SEQUENCE LISTING (27 sequences)

SEQ ID NO: 1 - protein, 165 aa, Brassica napus
MGILRKKKHERKPSFKSVLTAILATHAATFLLLIAGVSLAGTAAAFIATMPLFVVFSPILVPAGITTGLLTTGLAAAGGAGATAVTIILWLYKRATGKAPPKVLEKVLKKIIPGAAAAPAAAPGAAPAAAPAAAPAVAPAAAPAAAPAPKPAAPPAPKPAAAPSI

SEQ ID NO: 2 - protein, 193 aa, Brassica napus
MADVRTHAHQVQVHPLRQQEGGIKVVYPQSGPSSTQVLAVIAGVPVGGTLLTLAGLTLAGSVIGLMLAFPLFLIFSPVIVPAAFVIGLAMTGFMASGAIGLTGLSSMSWVLNHIRRVRERMPDELEEAKQRLADMAEYVGQRTKDAGQTIEEKAHDVRESKTYDVRDRDTKGHTATGGDRDTKTTREVRVATT

SEQ ID NO: 3 - protein, 188 aa, Brassica napus
MANVDRRVNVDRTDKGLQLQPQYEDRVGYGYGYGGNTDYKSCGPSTNQIVALIAGVPIGGSLLALAGLTLAGSVIGFMLSIPLFLLFSPVIVPAALTIGLAVTGILASGLFGLTGLSSVSWVLNYIRGRSDTVPEQLDYAKRRMADAVGYAGQKGKEMGQYVQDKAHEAHDTSLTTETNGKTRRAHIA

SEQ ID NO: 4 - protein, 180 aa, Brassica napus
MADTARTHHDITSRDQYPILGRDRDQYPYGRSDYQTSGQDYSKTRQIAKAATAVTAGGSLLVLSSLTLVGTVIALTVATTLLVIFSPILVPALITVALLITGFLSSGGFGIADITVFSWIYKYATGEHPQGSDKLDSARMKLGTKAQDIKDRAQYYGQQHTGGEHDRDRTRGTHHTTTTT

SEQ ID NO: 5 - protein, 210 aa, Brassica napus
MADTHRVDRTDRHLQFQSPYEGGRVSIQYEGGGGAGGYGGRGGGYGAEGYKSMMPERGPSSTQVLSFLVGVPIVGSLLAIAGLLLAGSVIGLLISIPLFLLFSPVIVPAALTIGLAATGFLASGMFGLTGLSSVSWVLNYLRGTRKSSVPEQLEYAKKRMADAVGYAGQKGKGMGQHVQNKAQEAKQYDISKTHDTTTKGHETTQRTAAA

SEQ ID NO: 6 - protein, 149 aa, Brassica napus
MANQTRTHQDIIVRDSRITLDRDHPKTGAQMVKVATGVAAGGSLLVLSGLTLAGTVIAFAVATPLLIIFSPVLVPAVITVVLIITGFLASGGFGIAAITAFSWLYRHMTGSGSDQKIESARMKVGSRGYDTKYGQHNIGVHQQHQQAAS

SEQ ID NO: 7 - protein, 137 aa, Arachis hypogaea
MAEALYYGGRQRQEQPRSTQLVKATTAVVAGGSLLILAGLVLAGTVIGLTTITPLFVIFSPVLVPAVITVALLGLGFLASGGFGVAAITVLTWIYRYVTGKHPPGANQLDTARHKLMGKAREIKDFGQQQTSGAQAS

SEQ ID NO: 8 - protein, 150 aa, Arachis hypogaea
MTDRTQPHAVQVHTTAGRFGDTAAGTNRYADRGPSTSKVIAVITGLPIGGTLLLFAGLALAGTLLGLAVTTPLFILFSPVIVPATIVVGLSVAGFLTSGACGLTGLSSFSWVMNYIRQTHGSVPEQLEMAKHRMADVAGYVGQKTKDVGQ

SEQ ID NO: 9 - protein, 166 aa, Arachis hypogaea
MSDQTRTGYGGGGSYGSSYGGGGTYGSSYGTSYDPSTNQPIRQAIKFMTASTIGVSFLILSGLILTGTVIGLIIATPLLVIFSPILVPAAITLALAAGGFLFSGGCGVAAIAALSWLYSYVTGKHPAGSDRLDYAKGVIADKARDVKDRAKDYAGAGRAQEGTPGY

SEQ ID NO: 10 - protein, 176 aa, Arachis hypogaea
MATATDRAPHQVQVHTPTTQRVDVPRRGYDVSGGGIKTLLPERGPSTSQIIAVLVGVPTGGTLLLLSGLSLLGTIIGLAIATPVFIFFSPVIVPAVVTIGLAVTGILTAGACGLTGLMSLSWMINFIRQVHGTTVPDQLDSVKRRMADMADYVGQKTKDAGQEIQTKAQDVKRSSS

SEQ ID NO: 11 - protein, 153 aa, Ricinus communis
MADRPQPHQVQVHRYDPTTGYKGQQKGPSASKVLAVLTFLPVGGGLLSLSGITLTNTLIGMAIATPLFILFGPIILPAAVVIGLAMMAFMVAGALGLSGLTSQSWALKYFREGTAMPESLDQAKKRMQDMAGYVGMKTKEVGQDIQRKAQEGK

SEQ ID NO: 12 - protein, 138 aa, Ricinus communis
MAEHQQSPVVSHRPRVNQLVKAGTAATAGSSLLFLSGLTLTGTVIALALATPLMVLFSPVLLPAVIIISLIGAGFLTSGGFGFGAILVLSWIYRYVTGKQPPGAESLDQARLKLAGKAREMKDRAEQFGQHVTGQQTS

SEQ ID NO: 13 - protein, 226 aa, Glycine max
MTTQVPPHSVQVHTTTTHRYEAGVVPPGARFETSYEAGVKAASIYHSERGPTTSQVLAVLAGLPVGGILLLLAGLTLAGTLTGLAVATPLFVLFSPVLVPATVAIGLAVAGFLTSGAFGLTALSSFSWILNYIRETQPASENLAAAAKHHLAEAAEYVGQKTKEVGQKTKEVGQDIQSKAQDTREAAARDAREAAARDAREAAARDAKVEARDVKRTTVTATTATA

SEQ ID NO: 14 - protein, 223 aa, Glycine max
MTTVPPHSVQVHTTTHRYEAGVVPPARFEAPRYEAGIKAPSSIYHSERGPTTSQVLAVVAGLPVGGILLLLAGLTLAGTLTGLVVATPLFIIFSPVLIPATVAIGLAVAGFLTSGVFGLTALSSFSWILNYIRETQPASENLAAAAKHHLAEAAEYVGQKTKEVGQKTKEVGQDIQSKAQDTREAAARDARDAREAAARDARDAKVEARDVKRTTVTATTATA

SEQ ID NO: 15 - protein, 155 aa, Linum usitatissimum
MDQTHQTYAGTTQNPSYGGGGTMYQQQQPRSYQAVKAATAATAGGSLIVLSGLILTATVISLIIATPLLVIFSPVLVPALITVGLLITGFLASGGFGVAAVTVLSWIYRYVTGGHPAGGDSLDQARSKLAGKAREVKDRASEFAQQHVTGGQQTS

SEQ ID NO: 16 - protein, 180 aa, Linum usitatissimum
MADRTTQPHQVQVHTQHHYPTGGAFGRYEGVLKGGPYHQQGTGSGPSASKVLAVMTALPIGGTLLALAGITLAGTMIGLAITTPIFVICSPVLVPAALLIGFAVSAFLASGMAGLTGLTSLSWFARYLQQAGQGVGVGVPDSFDQAKRRMQDAAGYMGQKTKEVGQEIQRKSQDVKASDK

SEQ ID NO: 17 - protein, 181 aa, Helianthus annuus
TTTTYDRHFTTTQPHYRQDDRSRYDQQTHSQSTSRTLAIIALLPVGGILLGLAALTFIGTLIGLALATPLFVIFSPIIVPAVLTIGLAVTGFLASGTFGLTGLSSLSYLFNMVRQTAGSVPESLDYVKGTLQDAGEYAGQKTKDFGQKIQSTAHEMGDQGQVGVHAQVGGGKEGRKSGDRT

SEQ ID NO: 18 - protein, 156 aa, Zea mays
MADHHRGATGGGGGYGDLQRGGGMHGEAQQQQKQGAMMTALKAATAATFGGSMLVLSGLILAGTVIALTVATPVLVIFSPVLVPAAIALALMAAGFVTSGGLGVAALSVFSWMYKYLTGKHPPAADQLDHAKARLASKARDVKDAAQHRIDQAQGS

SEQ ID NO: 19 - protein, 244 aa, Brassica napus
VSKPDDCRRIVDETISHFGRLDHLVNNAGIMQISMFENIEEITRTRAVMDTNFWGSVYTTRAALPYLRQSNGKIVAMSSSAAWLTAPRMSFYNASKAALLNFFETLRIELGSDVHITIVTPGYIESELTQGKYFSGEGELVVNQDIRDVQIGAFPVTSVSGCAKGIVKGVCRKQRYVTEPSWFKVTYLWKVFCPELIEWGCRLLFLSGHGTSEKNALNKKILDIPGVRSALYPESIRTPEIKSE

SEQ ID NO: 20 - protein, 349 aa, Brassica napus
MELINDFLNLTAPFFTFFGLCFFLPPFYFFKFVQSIFSTIFSENVYGKVVLITGASSGIGEQLAYEYASKGACLALTARRKNRLEEVAEIAREVGSPNVVTVHADVSKPDDCRRIVDETISHFGRLDHLVNNAGIMQISMFENIEEITRTRAVMDTNFWGAVYTTRAALPYLRQSNGKIVAMSSSAAWLTAPRMSFYNASKAALLNFFETLRIELGSDVHITIVTPGYIESELTQGKYVSGEGELVVNQDIRDVQIGAFPVTSVSGRAKGIVKGVCRKERYVTEPSWFKVTYLWKVFCPELIEWGCRLMFLSGHGTPEENALNKKILDIPGVRSALYPEPIRTPEIKSE

SEQ ID NO: 21 - protein, 456 aa, Brassica napus
MVDLLNSVMNLVAPPATMVVMAFSWPLLCFITFSERLYNSYFVTEDMEDKVVVITGASPAIGEQIAYEYAKRGANLVLVARREQRLRVVSNNARQIGANHVIIIAADVVKEDDCRRFITQAVNYYGRVDHLVNSASLGHTFYFDEVSDTTVFPHLLDINFWGNVYPTYVALPHLQKTNGRIVVNASVENWLPLPRMSLYSAAKAALVNFYETLRFELNGDVGITIATHGWIGSEMSRGKFMLEEGAEMQWKEEREVPANGGPLEEFAKMIVAGACRGDAYVKFPNWYDVFLLYRVFTPNVLRWTFKLLLSSEGSRQSSLVGVGQGLPPEESSSQMKLMLEGGSPRVTASPPRYTPSPSPPHHTASPPRYTPSPSPPHHTSSPQRYTPSPSPPHYTSSRHRYTPSPSPPHYTESPPLYTESPPHYTTSPNWYTESPPRYTPSPSPPRFSRFNIQELP

SEQ ID NO: 22 - protein, 348 aa, Sesamum indicum
MDLIHTFLNLIAPPFTFFFLLFFLPPFQIFKFFLSILGTLFSEDVAGKVVVITGASSGIGESLAYEYAKRGACLVLAARRERSLQEVAERARDLGSPDVVVVRADVSKAEDCRKVVDQTMNRFGRLDHLVNNAGIMSVSMLEEVEDITGYRETMDINFWGYVYMTRFAAPYLRNSRGRIVVLSSSSSWMPTPRMSFYNASKAAISQFFETLRVEFGPDIGITLVTPGFIESELTQGKFYNAGERVIDQDMRDVQVSTTPILRVESAARSIVRSAIRGERYVTEPAWFRVTYWWKLFCPEVMEWVFRLMYLASPGEPEKETFGKKVLDYTGVKSLLYPETVQVPEPKND

SEQ ID NO: 23 - protein, 350 aa, Zea mays
MLGMSRTGLAGAALRVALTALLPLVLPAYYVYKLTTYLLGAVFPEDVAGKVVLITGASSGIGEHLAYEYAKRGAYLALVARREASLREVGDVALGLGSPGVLVLPADVSKPRDCEGFIDDTISYFGRLDHLVNNASIWQVCKFEEIQDVRHLRALMDINFWGHVYPTRLAIPHLRRSRGRIVGVTSNSSYIFIGRNTFYNASKAAALSFYDTLRMELGSDIRITEVVPGVVESEITKGKMLTKGGEMKVDQDERDAILGPTPAEPVGDFARTVVRDVCRGARYVFEPRWYMGVYLLRACLPEVLAWNSRLLTVDTVGASTTDTLGKWLVELPGVRRVVQPPSLRSPEIKD

SEQ ID NO: 24 - protein, 245 aa, Brassica napus
MGTATEIMERDAMATVAPYAPVTFHRRARVDLDDRLPKPYMPRALQAPDREHPYGTPGHKNYGLSVLQQHVAFFDIDDNGIIYPWETYSGLRMIGFNIIGSLIIAAVINLALSYATLPGWLPSPFFPIYIHNIHKSKHGSDSRTYDNEGRFMPVNLELIFSKYAKTLPDKLSLGELWDMTEGQRDAWDIFGWFASKIEWGLLYLLARDEEGFLSKEAIRRCFDGSLFEYCAKIYVGINEDKTAYY

SEQ ID NO: 25 - protein, 244 aa, Brassica napus
MVRESMGEESEAFATTAPLAPVTGERKVRNDLEETLPKPYLARALVAPDTEHPNGSEGHDSKGMSVTQQHVAFFDQNGDGIVYPWETYAGFRDLGFNPISSVFWAIFINFAFSYVTLPSWLPSPLLPVYIDNIHKAKHGSDSSTYDTEGRYVPVNLENIFSKYALTAPNKITLKELWNLTEGNRMAIDPFGWLANKVEWLLVYLLAKDEEGFVSKEAVRGVFDASFFEYCAKKNKEKADSRKQD

SEQ ID NO: 26 - protein, 245 aa, Sesamum indicum
MATHVLAAAAERNAALAPDAPLAPVTMERPVRTDLETSIPKPYMARGLVAPDMDHPNGTPGHVHDNLSVLQQHCAFFDQDDNGIIYPWETYSGLRQIGFNVIASLIMAIVINVALSYPTLPGWIPSPFFPIYLYNIHKAKHGSDSGTYDTEGRYLPMNFENLFSKHARTMPDRLTLGELWSMTEANREAFDIFGWIASKMEWTLLYILARDQDGFLSKEAIRRCYDGSLFEYCAKMQRGAEDKMK

SEQ ID NO: 27 - protein, 243 aa, Zea mays
MSSYSPPPPPPRDQSMDTEAPNAPITRERRLNPDLQEQLPKPYLARALEAVDPSHPQGTKGRDPRGMSVLQQHAAFFDRNGDGVIYPWETFQGLRAIGCGLTVSFAFSILINLFLSYPTQPGWLPSPLLSIRIDNIHKGKHGSDSETYDTEGRFDPSKFDAIFSKYGRTHPNAITRDELSSMLQGNRNTYDFLGWLAAAGEWLLLYSLAKDKDGLLQRETVRGLFDGSLFERLEDDNNKKKSS

(19) United States
(12) Patent Application Publication
(10) Pub. No.: US 2014/0024714 A1
(43) Pub. Date: Jan. 23, 2014

(54) ARTIFICIAL OIL BODIES

(71) Applicants: Rajendranatha Chakrapani Wijesundera, Dandenong North (AU); Zhiping Shen, Wyndham Vale (AU); Thomas Boiteau, Joue les tours (FR); Xinqing Xu, Truganina (AU); Leif Lundin, Wandana Heights (AU)

(72) Inventors: Rajendranatha Chakrapani Wijesundera, Dandenong North (AU); Zhiping Shen, Wyndham Vale (AU); Thomas Boiteau, Joue les tours (FR); Xinqing Xu, Truganina (AU); Leif Lundin, Wandana Heights (AU)

(73) Assignee: Commonwealth Scientific and Industrial Research Organisation, Australian Capitol Territory (AU)

(21) Appl. No.: 13/984,219

(22) PCT Filed: Feb. 7, 2012
(86) PCT No.: PCT/AU12/00103

§ 371 Date: Sep. 27, 2013

(30) Foreign Application Priority Data
Feb. 7, 2011 (AU) 2011900383

(51) Int. Cl. A23D 7/005

(52) U.S. Cl. CPC A23D 7/0053
USPC 514/560; 426/601; 426/495; 426/425; 514/773

(57) ABSTRACT

The present invention relates to artificial oil bodies comprising oleosin (which, as presently defined, also encompasses caleosin, steroleosin and polyoleosin), a surfactant such as a phospholipid, and an oil comprising fatty acids, such as polyunsaturated fatty acids having four or more double bonds. The present invention also relates to methods of preparing said artificial oil bodies. These AOBs may further comprise other molecules such as bioactive molecules, used in a wide variety of products, and are particularly useful for producing oxidatively stable oil-in-water emulsions in the absence of added antioxidants. The present invention further encompasses a method for the partial purification of oleosin from a plant extract.

### FIELD OF THE INVENTION

The present invention relates to artificial oil bodies comprising fatty acids, and methods of preparing said artificial oil bodies. The artificial oil bodies can be used in a wide variety of products, and are particularly useful for producing oxidatively stable oil-in-water emulsions in the absence of antioxidants.

### BACKGROUND OF THE INVENTION

Fat has a high calorific content and makes a major contribution to the human dietary energy intake. Certain types of fat such as saturated fats and trans fats have been implicated in a range of disease conditions including cardiovascular disease. However, fat also plays a positive role in human health and nutrition, and international dietary guidelines allow a certain proportion of dietary energy to be derived from fat as long as it is ‘good fat’. The ‘good fats’ are monounsaturated and polyunsaturated oils, and there is increasing interest in replacement of saturated fats in food products with healthier unsaturated oils. Moreover, for many years now, a particular group of polyunsaturated oils, namely long-chain omega-3 oils, have received considerable attention due to a multitude of health benefits including protection against cardiovascular disease which have been attributed to them. Spurred by the growing list of health benefits of omega-3 oils, the food industry worldwide is striving to produce food products fortified with omega-3 oils.

One of the major impediments to the expansion of omega-3 fortified foods and similar healthy foods containing highly unsaturated oil is the extreme susceptibility of these oils to oxidative deterioration during storage. Oxidation generates products some of which can have highly undesirable flavour characteristics thereby reducing the palatability and shelf-life of the product. It is important therefore to adequately protect these oils from oxidation. Whilst microencapsulation and addition of anti-oxidants have successfully been used as strategies to control oxidation of highly unsaturated oils in food products, these technologies have several drawbacks in relation to cost, naturalness, and general applicability.

Oil in plants and oilseeds occurs in the form of discrete deposits referred to as oil bodies (OBs) which are similar in structure irrespective of the plant species they are present in. A remarkable feature of natural OBs is their exceptional physical stability both inside the cells and in isolated preparations. In both situations, OBs occur as individual entities, and do not aggregate or coalesce when they are pressed against one another even after prolonged storage; in vivo due to desiccation, and in vitro after flotation centrifugation (Tzen and Huang, 1992). The exceptional physical stability of OBs has been attributed to unique amphipathic proteins called oleosins occurring in the oil body surface (Huang, 1994). It has been suggested that the entire surface of the oil body is covered by oleosin such that the compressed OBs never coalesce or aggregate in the cells of a mature seed (Tzen and Huang, 1992). The content of oleosin ranges from 1-4% of the total oil bodies; the greatest amount occurring in species in which the OBs are the smallest, e.g. rape/canola (Huang, 1992; Tzen, 1993).

In addition to good physical stability, OBs within oilseeds have natural protection against oxidation. Recent studies have shown that this oxidative stability is extended to aqueous dispersions oil body isolates. Fisk and co-workers (2008) showed intact OBs extracted from sunflower seed and dispersed in continuous aqueous phase were more resistant to oxidation than equivalent emulsions prepared from sunflower oil and emulsifier. More recently, similar results have been obtained for echium oil body isolates containing the highly unsaturated stearidonic acid (Gray et al, 2010). Superior oxidative stability of aqueous dispersions of intact canola OBs over equivalent canola oil-in-water emulsions prepared using Tween40 as the emulsifier has also been reported (Shen and Wijesundera, 2009).

Limited attempts have been made to reassemble OBs from their constituents. Murphy and Cummins (1989) reported that incubation of TAG extracted from rapeseed oil or purified triolein with rapeseed oil body membrane material resulted in the appearance of oil stable droplets of similar dimensions to native oil bodies. Later, Tzen and Huang (1992) successfully prepared physically stable artificial (reconstituted) oil bodies (AOBs) by combining a TAG mixture of triolein and trilinolein (1:2 molar) with dioleoyl phosphatidylcholine and oleosin isolated from wheat, rice, rapeseed, soybean or jojoba. However, the oxidative stability of such artificial OBs does not seem to have been investigated.

There is a need for means to protect fatty acids from oxidation which do not rely on the use of added antioxidants.

### SUMMARY OF THE INVENTION

Oils containing high levels of polyunsaturated fatty acids with four or more double bonds, such as marine oils rich in ω3 fatty acids, are chemically distinct from oils produced in plants such as oilseeds. However, the present inventors were surprised to find that oleosin extracted from plant meal, such as commercial canola meal, can be used to construct artificial oil bodies with highly polyunsaturated oils, such as ω3 fatty acid rich marine and/or fish oils. The present inventors where also surprised to find that the phospholipid component of oil bodies could be substituted with a wide variety of surfactants without adversely affecting oxidative stability.

Thus, in a first aspect the present invention provides an artificial oil body comprising oleosin, surfactant, and oil comprising polyunsaturated fatty acids with three or more double bonds, more preferably four or more double bonds.

In an embodiment, the surfactant is phospholipid.

In an embodiment, at least 5%, at least 10%, at least 15%, at least 20% or at least 25%, of the polyunsaturated fatty acids have four or more double bonds.

In another aspect, the present invention provides an artificial oil body comprising oleosin, surfactant, and oil comprising fatty acids, wherein at least some of the surfactant is not phospholipid.

Whilst the oleosin can be obtained from any source, in a preferred embodiment the oleosin is an oilseed oleosin.

The oil may also be obtained from any source. In a preferred embodiment, the oil is marine oil and/or fish oil.

In a further embodiment, at least 50%, at least 75%, or at least 90%, of the fatty acids are in the form of glycerides.

In an embodiment, at least 80%, at least 90%, or at least 95%, of the dry weight of artificial oil body is oil.

The oil bodies of the invention can be used as a carrier for, and hence may further comprise, one or more other molecules. Examples such other molecules include, but are not limited to, a probiotic, a preservative, a therapeutic agent, a diagnostic agent, a delivery agent or a food colouring agent.

The size of the oil body can be varied by manipulating the relative concentration of oil to oleosin, with lower relative amounts of oleosin promoting larger sizes. In an embodiment, the oil body has a size of between about 0.1 and about 100 μm, or at least between about 0.5 and about 50 μm, or at least between about 0.5 and about 10 μm, or at least between about 0.5 and about 2 μm.

In yet a further aspect, the present invention provides a composition comprising one or more artificial oil bodies of the invention, and a carrier. In an embodiment, the carrier is deionized water.

In an embodiment, the composition is an oil-in-water emulsion. In particular, an oil-in-water emulsion of the invention is more resistant to oxidation than an oil-in-water emulsion comprising fatty acids produced using as an emulsifier such as Tween40 in the absence of oleosin.

The present inventors have found that the artificial oil bodies of the invention are generally resistant to oxidation. Thus, in an embodiment, the artificial oil bodies and/or composition does not comprise a synthetic antioxidant. Furthermore, in a preferred embodiment the artificial oil bodies of the invention are oxidatively stable.

In an embodiment, the artificial oil body consists of oleosin, surfactant, and oil comprising fatty acids such as polyunsaturated fatty acids with four or more double bonds.

Apart from being useful in the delivery of a therapeutic agent, artificial oil bodies of the invention can be used to treat or prevent diseases due to the well known benefits of the fatty acids, particularly polyunsaturated fatty acids, of the oil bodies. Thus, in a further aspect, the present invention provides a method of treating or preventing a condition which would benefit from fatty acids, the method comprising administering to a subject with the condition one or more oil bodies of the invention and/or a composition of the invention.

Also provided is the use of one or more oil bodies of the invention and/or a composition of the invention for the manufacture of a medicament for treating or preventing a condition which would benefit from fatty acids.

Furthermore, provided is the use of one or more oil bodies of the invention and/or a composition of the invention as a medicament for treating or preventing a condition which would benefit from fatty acids.

In an embodiment of the above method and uses, the condition would benefit from polyunsaturated fatty acids with four or more double bonds.

The oil bodies can be used in a wide variety of products. Accordingly, in another aspect the present invention provides a product comprising one or more artificial oil bodies, and/or a composition, of the invention. Examples of such products include, but are limited to, a food or feed product, a drink product, a personal care product, a pharmaceutical product or an industrial product.

In a preferred embodiment, the product is, or comprises, an oil-in-water emulsion.

Also provided is the use of one or more artificial oil bodies of the invention, and/or a composition of the invention, for the preparation of a product.

In a further aspect, the present invention provides a method of preparing a feed, food or drink, the method comprising admixing one or more artificial oil bodies of the invention, and/or a composition of the invention, with one or more other edible ingredients.

In a further aspect, the present invention provides a method of producing artificial oil bodies, the method comprising

i) obtaining oleosin, surfactant, and oil comprising polyunsaturated fatty acids with four or more double bonds, and

ii) mixing the oleosin, the surfactant and the oil to produce the artificial oil bodies.

In another aspect, the present invention provides a method of producing artificial oil bodies, the method comprising

i) obtaining oleosin, surfactant, and oil comprising fatty acids, wherein at least some of the surfactant is not phospholipid, and

ii) mixing the oleosin, the surfactant and the oil to produce the artificial oil bodies.

In an embodiment, the surfactant is mixed and dissolved in the oil before mixing in the olesoin.

In a further embodiment, the method further comprises,

iii) selecting artificial oil bodies.

The present inventors have also identified methods of obtaining oleosin for use in the artificial oil bodies of the invention. The present inventors were particularly surprised to find that a protein extract comprising a highly heterogeneous population of proteins with relatively low quantities of oleosin (for example about 10% of the total protein) could be used, with the natural affinity of the oil, surfactant and oleosin seemingly being highly efficient at forming the artificial oil bodies. This is particularly advantageous because it avoids the need to conduct extensive purification procedures and provides a relatively cheap source of the oleosin. Thus, in a further embodiment, step i) comprises

a) obtaining an extract of a plant comprising oleosin, and

b) at least partially purifying protein from the extract, wherein the protein comprises oleosin.

Preferably, step b) comprises

1) adjusting the pH of the extract to a pH of at least about 11.5,

2) separating 1) to produce a solid and liquid phase and selecting the liquid phase,

3) reducing the pH of the liquid phase to precipitate the proteins,

4) separating 3) to produce a solid and liquid phase and selecting the solid phase, and

5) dispersing the solid phase in a carrier.

The present invention also provides an artificial oil body produced by a method of the invention.

In a further aspect, the present invention provides a method of partially purifying oleosin from a plant extract, the method comprising

1) adjusting the pH of the extract to a pH of at least about 11.5,

2) separating 1) to produce a solid and liquid phase and selecting the liquid phase,

3) reducing the pH of the liquid phase to precipitate the proteins,

4) separating 3) to produce a solid and liquid phase and selecting the solid phase, and

5) dispersing the solid phase in a carrier.

In an embodiment, step 3) comprises reducing the pH of the liquid phase to less than about 7, to about pH 4 to about 7, or about pH 5.5 to about 7.

Preferably, the method of the two above aspects does not use an organic solvent.

The extract can be from any plant such as plant meal. However, in a preferred embodiment the plant is an oilseed.

The present inventors have also found that meal resulting from the extraction of oils from plant material, such as the seeds of oilseeds, can be used as a source for oleosin. As an added benefit of the claimed invention, following the partial purification of the oleosin the remaining plant extract can be used as an animal feed. Thus, in a preferred embodiment the extract is meal produced following the extraction of oil.

The present invention also provides at least partially purified oleosin produced by a method of the invention.

Any embodiment herein shall be taken to apply mutatis mutandis to any other embodiment unless specifically stated otherwise.

The present invention is not to be limited in scope by the specific embodiments described herein, which are intended for the purpose of exemplification only. Functionally-equivalent products, compositions and methods are clearly within the scope of the invention, as described herein.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or group of compositions of matter.

The invention is hereinafter described by way of the following non-limiting Examples and with reference to the accompanying figures.

### BRIEF DESCRIPTION OF THE ACCOMPANYING DRAWINGS

FIG. 1: Procedure for the extraction of oleosin from canola meal.

FIG. 2: Electrophoretic analysis of oleosin extract from canola meal.

FIG. 3: Effect of pH of the extracting medium on oleosin recoveries from canola meal.

FIG. 4: Electrophoretic analysis of oleosin extracted at different pH values. Lane 2 and 3—pH 10.5; Lane 4 and 5—pH 11.0; Lane 6 and 7—pH 11.5; Lane 8 and 9—pH 12.0.

FIG. 5: Change in particle size (μm) of D[3,2} and d (0.5) for Tween 40 and olesoin emulsions subjected to accelerated auto oxidation (60° C.). Average data from duplicate measurements.

FIG. 6: Electrophoretic analysis of surface proteins of artificial tuna oil bodies. Lanes: M—markers, Raw pH12-pH12 soluble crude protein extract from canola meal, CP1—protein extracted from artificial canola oil bodies made from canola oil and re-solubilised pH 6.5-precipitated canola meal protein, CP1+PLs—protein extracted from artificial canola oil bodies made from canola oil, re-solubilised pH 6.5-precipitated canola meal protein, and phospholipids.

FIG. 7: Development of trans,trans,2,4,heptadienal during accelerated oxidation of tuna oil emulsions prepared with Tween40 and Oleosin extract, respectively. Average data from duplicate measurements. 7A—Oxidation at 60° C.; 7B—Oxidation at 40° C.

FIG. 8: Depletion of EPA and DHA in tuna oil emulsions made with Tween40 and Oleosin extract (respectively) during storage at 60° C. Average data from duplicate measurements. 8A—Oxidation at 60° C.; 8B—Oxidation at 40° C.

FIG. 9: Peroxide value (PV) of oils extracted from tuna oil artificial oil body emulsions and equivalent Tween40 emulsions subjected to accelerated oxidation at 40° C.

FIG. 10: Development of trans, trans, 2,4-heptadienal during accelerated storage (40° C., air) of tuna oil emulsions stabilised by oleosin, Isolexx and sodium caseinate, respectively.

FIG. 11: Development of trans, trans, 2,4-heptadienal during accelerated storage (40° C., air) of tuna oil emulsions prepared using oleosin in combination with monoacylglycerol (MAG), Tween40 (Tween), and sodium stearoyl lactylate (SSL), receptively as the secondary surfactant.

### KEY TO THE SEQUENCE LISTING

SEQ ID NO 1: Brassica napus oleosin (CAA57545.1)
SEQ ID NO 2: Brassica napus oleosin S1-1 (ACG69504.1)
SEQ ID NO 3: Brassica napus oleosin S2-1 (ACG69503.1)
SEQ ID NO 4: Brassica napus oleosin S3-1 (ACG69513.1)
SEQ ID NO 5: Brassica napus oleosin S4-1 (ACG69507.1)
SEQ ID NO 6: Brassica napus oleosin S5-1 (ACG69511.1)
SEQ ID NO 7: Arachis hypogaea oleosin 1 (AAZ20276.1)
SEQ ID NO 8: Arachis hypogaea oleosin 2 (AAU21500.1)
SEQ ID NO 9: Arachis hypogaea oleosin 3 (AAU21501.1)
SEQ ID NO 10: Arachis hypogaea oleosin 5 (ABC96763.1)
SEQ ID NO 11: Ricinus communis oleosin 1 (EEF40948.1)
SEQ ID NO 12: Ricinus communis oleosin 2 (EEF51616.1)
SEQ ID NO 13: Glycine max oleosin isoform a (P29530.2)
SEQ ID NO 14: Glycine max oleosin isoform b (P29531.1)
SEQ ID NO 15: Linum usitatissimum oleosin low molecular weight isoform (ABB01622.1)
SEQ ID NO 16: Linum usitatissimum oleosin high molecular weight isoform (ABB01624.1)
SEQ ID NO 17: Helianthus annuus oleosin (CAA44224.1)
SEQ ID NO 18: Zea mays oleosin (NP_{—}001105338.1)
SEQ ID NO 19: Brassica napus steroleosin (ABM30178.1)
SEQ ID NO 20: Brassica napus steroleosin SLO1-1 (ACG69522.1)
SEQ ID NO 21: Brassica napus steroleosin SLO2-1 (ACG69525.1)
SEQ ID NO 22: Sesamum indicum steroleosin (AAL13315.1)
SEQ ID NO 23: Zea mays steroleosin (NP_{—}001152614.1)
SEQ ID NO 24: Brassica napus caleosin CLO-1 (ACG69529.1)
SEQ ID NO 25: Brassica napus caleosin CLO-3 (ACG69527.1)
SEQ ID NO 26: Sesamum indicum caleosin (AAF13743.1)
SEQ ID NO 27: Zea mays caleosin (NP_{—}001151906.1)

### DETAILED DESCRIPTION OF THE INVENTION

### General Techniques and Definitions

Unless specifically defined otherwise, all technical and scientific terms used herein shall be taken to have the same meaning as commonly understood by one of ordinary skill in the art (e.g., in lipid chemistry, molecular genetics, chemistry, and biochemistry).

Unless otherwise indicated, the recombinant protein, cell culture, and immunological techniques utilized in the present invention are standard procedures, well known to those skilled in the art. Such techniques are described and explained throughout the literature in sources such as, J. Perbal, A Practical Guide to Molecular Cloning, John Wiley and Sons (1984), J. Sambrook et al., Molecular Cloning: A Laboratory Manual, Cold Spring Harbour Laboratory Press (1989), T. A. Brown (editor), Essential Molecular Biology: A Practical Approach, Volumes 1 and 2, IRL Press (1991), D. M. Glover and B. D. Hames (editors), DNA Cloning: A Practical Approach, Volumes 1-4, IRL Press (1995 and 1996), and F. M. Ausubel et al. (editors), Current Protocols in Molecular Biology, Greene Pub. Associates and Wiley-Interscience (1988, including all updates until present).

The term “and/or”, e.g., “X and/or Y” shall be understood to mean either “X and Y” or “X or Y” and shall be taken to provide explicit support for both meanings or for either meaning.

As used herein, the term about, unless stated to the contrary, refers to +/−20%, more preferably +/−10%, even more preferably +/−5%, of the designated value.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### Oils and Fatty Acids

As used herein, the term “fatty acid” refers to a carboxylic acid with a long aliphatic tail of at least 8 carbon atoms in length, either saturated or unsaturated. Typically, fatty acids have a carbon-carbon bonded chain of at least 12 carbons in length. Most naturally occurring fatty acids have an even number of carbon atoms because their biosynthesis involves acetate which has two carbon atoms. The fatty acids may be in a free state (non-esterified) or in an esterified form such as part of a TAG, DAG, MAG, acyl-CoA (thio-ester) bound, or other covalently bound form. When covalently bound in an esterified form, the fatty acid is referred to herein as an “acyl” group. Saturated fatty acids do not contain any double bonds or other functional groups along the chain. The term “saturated” refers to hydrogen, in that all carbons (apart from the carboxylic acid [—COOH] group) contain as many hydrogens as possible. In other words, the omega (ω) end contains 3 hydrogens (CH3-) and each carbon within the chain contains 2 hydrogens (—CH2-). Unsaturated fatty acids are of similar form to saturated fatty acids, except that one or more alkene functional groups exist along the chain, with each alkene substituting a singly-bonded “—CH2-CH2-” part of the chain with a doubly-bonded “—CH═CH—” portion (that is, a carbon double bonded to another carbon). The two next carbon atoms in the chain that are bound to either side of the double bond can occur in a cis or trans configuration. Apart from double bonds, the acyl chain of the fatty acid may have, triple bonds, acyl side chains such a methyl or ethyl groups, hydroxyl groups or other modifications known in the art. Artificial oil bodies of the invention may include fatty acids such as, but not limited to, stearic acid, palmitic acid, oleic acid, linoleic acid, α-linolenic acid, or a combination of two or more thereof.

As used herein, the terms “polyunsaturated fatty acid” or “PUFA” refer to a fatty acid which comprises at least 18 carbon atoms in its carbon chain and at least three, more preferably at least four, alkene groups (carbon-carbon double bonds). One aspect of the invention relates to artificial oil bodies comprising polyunsaturated fatty acids (PUFAs) with four or more double bonds. Examples of such PUFAs include, but are not limited to, stearidonic acid (SDA, 18:4Δ6,9,12,15, ω3), arachidonic acid (ARA, 20:4Δ5,8,11,14; ω6), eicosatetraenoic acid (ETA, 20:4Δ8,11,14,17, ω3), eicosapentaenoic acid (EPA, 20:5Δ5,8,11,14,17; ω3), docosapentaenoic acid (DPA, 22:5Δ7,10,13,16,19, ω3), docosahexaenoic acid (DHA, 22:6Δ4,7,10,13,16,19, ω3), as well as mixtures of two or more thereof. The artificial oil bodies may further comprise other fatty acids such as those described above with, for example, two or less double bonds, triple bonds, side chains such as a methyl group, a hydroxyl group and/or an epoxide group.

The fatty acid may be in a free state (non-esterified) or in an esterified form such as part of a triglyceride, diacylglyceride, monoacylglyceride, acyl-CoA bound or other bound form, or mixtures of two or more thereof. The fatty acid may be esterified as a phospholipid such as a phosphatidylcholine, phosphatidylethanolamine, phosphatidylserine, phosphatidylglycerol, phosphatidylinositol or diphosphatidylglycerol forms.

The term “glyceride” as used herein encompasses lipids selected from the group consisting of triglycerides, diglycerides, monoglycerides, phosphoglycerides and combinations thereof. More preferably, the glycerides are selected from the group consisting of triglycerides and diglycerides. Most preferably, the glyceride is triglyceride oil.

“Triacylglycerol” or (TAG) is glyceride in which the glycerol is esterified with three fatty acids. In the Kennedy pathway of TAG synthesis, the precursor sn-glycerol-3-phosphate is esterified by a fatty acid coenzyme A ester in a reaction catalysed by a glycerol-3-phosphate acyltransferase at position sn-1 to form lysophosphatidic acid (LPA), and this is in turn acylated by an acylglycerophosphate acyltransferase in position sn-2 to form phosphatidic acid. The phosphate group is removed by the enzyme phosphatidic phosphohydrolase, and the resultant 1,2-diacyl-sn-glycerol is acylated to form the triacyl-sn-glycerol.

In one embodiment, the glyceride (preferably, TAG) content of the oil comprises essentially the all (for example at least 75%, or at least 90%, or at least 95%) of the fatty acids.

The oil comprising fatty acids can be obtained from a wide variety of sources including micro-organisms including yeast, crusteceans, fish, animals and plants. The organism may or may not be genetically modified.

In an embodiment, seedoil is present in the artificial oil bodies. As used herein, the term “seedoil” refers to a composition obtained from the seed/grain of a plant which comprises at least 60% (w/w) lipid, or obtainable from the seed/grain if the seedoil is still present in the seed/grain. That is, seedoil includes seedoil which is present in the seed/grain or portion thereof, as well as seedoil which has been extracted from the seed/grain. The seedoil is preferably extracted seedoil. Seedoil is typically a liquid at room temperature. Preferably, the total fatty acid (TFA) content in the seedoil predominantly (>50%) comprises fatty acids that are at least 16 carbons in length. More preferably, at least 50% of the total fatty acids in the seedoil are C18 fatty acids for example, oleic acid. The fatty acids are typically in an esterified form such as for example, TAG, DAG, acyl-CoA or phospholipid. The fatty acids may be free fatty acids and/or in an esterified form. In an embodiment, seedoil in the artificial oil bodies is “substantially purified” or “purified” oil that has been separated from one or more other lipids (with the exception of phospholipids), nucleic acids, polypeptides (with the exception of oleosin), or other contaminating molecules with which it is associated in the seed or in a crude extract. It is preferred that the substantially purified seedoil is at least 60% free, more preferably at least 75% free, and more preferably, at least 90% free from other components with which it is associated in the seed or extract. Seedoil may further comprise non-fatty acid molecules such as, but not limited to, sterols and phenolics. In an embodiment, the seedoil is canola oil (Brassica napus, Brassica rapa ssp.), mustard oil (Brassica juncea), other Brassica oil (e.g., Brassica napobrassica, Brassica camelina), sunflower oil (Helianthus annus), linseed oil (Linum usitatissimum), soybean oil (Glycine max), safflower oil (Carthamus tinctorius), corn oil (Zea mays), tobacco oil (Nicotiana tabacum), peanut oil (Arachis hypogaea), palm oil (Elaeis guineensis), cottonseed oil (Gossypium hirsutum), coconut oil (Cocos nucifera), avocado oil (Persea americana), olive oil (Olea europaea), cashew oil (Anacardium occidentale), macadamia oil (Macadamia intergrifolia), almond oil (Prunus amygdalus), oat seed oil (Avena sativa), rice oil (Oryza sativa or Oryza glaberrima), or Arabidopsis seed oil (Arabidopsis thaliana). Seedoil may be extracted from seed/grain by any method known in the art. This typically involves extraction with nonpolar solvents such as diethyl ether, petroleum ether, chloroform/methanol or butanol mixtures, generally associated with first crushing of the seeds. Lipids associated with the starch in the grain may be extracted with water-saturated butanol. The seedoil may be “de-gummed” by methods known in the art to remove polysaccharides or treated in other ways to remove contaminants or improve purity, stability, or colour. The TAGs and other esters in the seedoil may be hydrolysed to release free fatty acids, or the seedoil hydrogenated, treated chemically, or enzymatically as known in the art.

As used herein, “marine oil” is oil obtained from an organism that lives in salt water, particularly marine microalgae, fish or crusteceans. Thus, an oil for use in the invention may be both a marine oil and a fish oil oil derived from a saltwater fish.

The oil comprising polyunsaturated fatty acids with four or more double bonds may be obtained from any source, such as oil extracted from marine micro-organisms, crustaceans, fish or transgenic organisms, such a transgenic plants or yeast, comprising exogenous polynucleotides which enable the organisms to synthesize polyunsaturated fatty acids with four or more double bonds. Examples of marine micro-organisms from which the PUFAs may be obtained include, but are not limited to, species of Amphidinium, Amphor, Asterionella, Biddulphia, Ceratium, Chaetoceros, Chlorella, Chroomonas, Cochlodinium, Crisphaera, Crypthecodinium, Cryptomonas, Cyclotella, Cylindrotheca, Duniella, Emiliania, Fragilaria, Glenodinium, Gonyaulax, Gyrodinium, Haematococcus pluvialis, Heteromastix, Isochrysis, Lauderia, Monochrysis, Monodus, Moritella, Mortierella, Nannochloris, Nannochloropis, Navicula, Nitzschia, Odontella, Olisthodiscus, Pavlova, Peridinium, Phaeodactylum, Porphyridium, Prorocentrum, Pseudopedinella, Rhodella, Rhododomas, Schizochytrium, Skelentonema, Stauroneis, Tetraselmis, Thalassiosira, Thrautochytrium, or Ulkenia. Examples of fish oils useful for the invention include, but are not limited to, tuna oil, bonito oil, sea bass oil, halibut oil, spearfish oil, barracuda oil, cod oil, menhaden oil, sardine oil, pilchard oil, anchovy oil, capelin oil, Atlantic cod oil, Atlantic herring oil, Atlantic mackerel oil, Atlantic menhaden oil, salmonids oil, shark oil, squid oil, octopus oil, krill oil, seal oil, whale oil, and the like, including mixtures and combinations thereof. Examples of transgenic organisms producing polyunsaturated fatty acids with four or more double bonds are described in, for example, WO 2005/103253, WO 2007/106905, WO 2010/023202, WO 2010/057246 and WO 2012/000026.

As noted above, techniques that are routinely practiced in the art can be used to extract and process oils produced by cells, plants, seeds, etc. For example, oil extraction may comprise degumming (or acid treatment), neutralization (or alkali treatment), water washing, bleaching, filtering, deodorising, polishing and/or cooling (or winterization). Preferably the purifying comprises acid treatment and/or alkali treatment (degumming and neutralisation). Alternatively, purifying methods may comprise bleaching and/or deodorization. Preferably, however, the purifying will involve bleaching and/or deodorization, and optimally in addition acid and alkali treatment.

### Oleosin

Oleosins are hydrophobic proteins present in the membrane of oil bodies in the storage tissues of seeds (see, for example, Huang, 1996; Lin et al., 2005; Capuano et al., 2007; Lui et al., 2009; Shimada and Hara-Nishimura, 2010). They are of low MW (15-26,000), and are abundant in oilseeds. Within each seed species, there are usually two or more oleosins of different MW. Each oleosin molecule contains a relatively hydrophilic N-terminal domain (for example about 48 amino acid residues), a central totally hydrophobic domain (for example of about 70-80 amino acid residues) which is particularly rich in aliphatic amino acids such as alanine, glycine, leucine, isoleucine and valine, and an amphipathic α-helical domain (for example about of about 33 amino acid residues) at or near the C-terminus. Generally, the central stretch of hydrophobic residues is inserted into the lipid core and the amphiphatic N-terminal and/or amphiphatic C-terminal are located at the surface of the oil bodies, with positively charged residues embedded in a surfactant monolayer and the negatively charged ones exposed to the exterior.

As used herein, the term “oleosin” encompasses caleosins which bind calcium, and steroleosins which bind sterols, as well as polyoleosin (Scott et al., 2010). However, generally a large proportion, if not all, of the oleosins of artificial oil bodies of the invention will not be caleosins and/or steroleosins. Furthermore, the term “oleosin” as used herein refers to either a homogenous population of the same oleosin protein, or more typically a heterogenous, population of different oleosin proteins.

A substantial number of oleosin protein sequences, and nucleotide sequences encoding therefor, are known from a large number of different plant species. Examples include, but are not limited to, oleosins from Arabidposis, canola, corn, rice, peanut, castor, soybean, flax, grape, cabbage, cotton, sunflower, sorghum and barley. Examples of some of these oleosins are provided in the Sequence Listing. Thus, in one embodiment, the oleosin comprises a sequence selected from:

a) an amino acid sequence as provided in any one of SEQ ID NOs 1 to 27,

b) an amino acid sequence which is at least 50% identical, more preferably at least 60%, more preferably at least 70%, more preferably at least 80%, preferably at least 90%, more preferably at least 95%, more preferably at least 96%, more preferably at least 97%, more preferably at least 98%, more preferably at least 99%, identical to any one or more of SEQ ID NOs 1 to 27, and

c) a biologically active fragment of a) or b).

In a further embodiment, the oleosin comprises a sequence selected from:

a) an amino acid sequence as provided in any one of SEQ ID NOs 1 to 18,

b) an amino acid sequence which is at least 50% identical, more preferably at least 60%, more preferably at least 70%, more preferably at least 80%, preferably at least 90%, more preferably at least 95%, more preferably at least 96%, more preferably at least 97%, more preferably at least 98%, more preferably at least 99%, identical to any one or more of SEQ ID NOs 1 to 18, and

c) a biologically active fragment of a) or b).

The % identity of a protein is determined by GAP (Needleman and Wunsch, 1970) analysis (GCG program) with a gap creation penalty=5, and a gap extension penalty=0.3. The query sequence is at least 50 amino acids in length, and the GAP analysis aligns the two sequences over a region of at least 50 amino acids. More preferably, the query sequence is at least 100 amino acids in length and the GAP analysis aligns the two sequences over a region of at least 100 amino acids. Even more preferably, the query sequence is at least 250 amino acids in length and the GAP analysis aligns the two sequences over a region of at least 250 amino acids. Even more preferably, the GAP analysis aligns the two sequences over their entire length.

As used herein, a “biologically active” fragment is a portion of an oleosin that can be used to prepare an artificial oil body of the invention. Biologically active fragments can be any size as long as they maintain the defined activity.

In a preferred embodiment, the oleosin is obtained from an oilseed such as, but not limited to, canola (Brassica spp.), soybean (Glycine max), sunflower (Helianthus annuus), oil palm (Elaeis guineeis), cottonseed (Gossypium spp.), groundnut (Arachis hypogaea), coconut (Cocus nucifera), castor (Ricinus communis), safflower (Carthamus tinctorius), mustard (Brassica spp. and Sinapis alba), coriander (Coriandrum sativum), squash (Cucurbita maxima), linseed/flax (Linum usitatissimum), Brazil nut (Bertholletia excelsa), jojoba (Simmondsia chinensis) or maize (Zea mays).

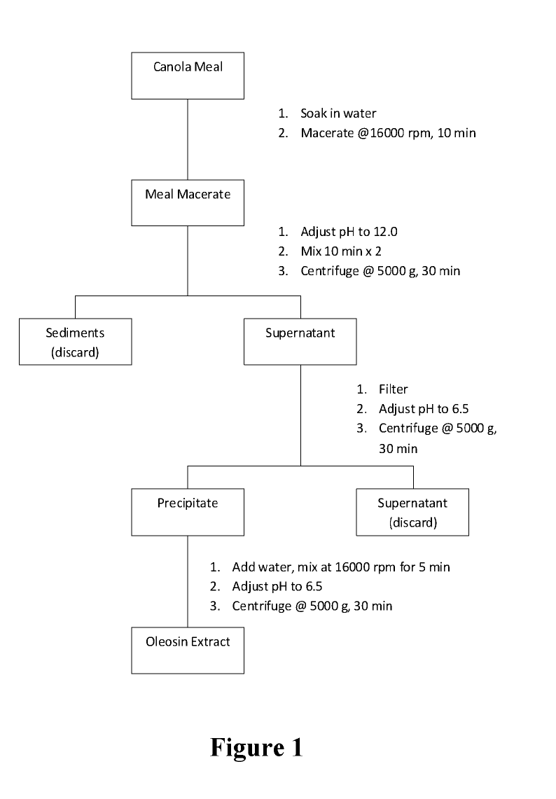

The oleosin may be obtained from a natural, synthetic or recombinant source. Advantageously, the oleosin can be obtained from a natural source such as a plant extract, particularly the meal of an oilseed following oil extraction. FIG. 1 shows an example of a procedure used to extract oleosin from plant meal such as canola meal. Approximately 50% of the canola meal protein has been reported to precipitate at pH 6.0-7.0 (Manamperi et al., 2010). Canola meal typically contains up to 40% protein derived mainly from seed cellular protein. Commercial oil extraction processes of mechanical expelling followed by solvent extraction disrupt the canola oil body structure thereby releasing oleosin to the mix of the relatively more abundant cellular proteins. As the isoelectric point of canola oleosin is 6.5, the protein precipitated at the pH range 6.0-7.0 contains oleosin in addition to cellular protein.

The oleosin may also be obtained from a recombinant source, either plants with an exogenous gene(s) encoding an oleosin resulting in enhanced levels of oleosin production, or a recombinant organism comprising an exogenous gene(s) but do not naturally produce an oleosin, for example a recombinant yeast. The production of recombinant organisms producing, and/or with enhanced levels of, oleosin is well within the capability of those skilled in the art (see, for example, Roux et al., 2004; Abenes et al., 1997; Bhatla et al., 2010).

Amino acid sequence mutants of the naturally occurring oleosins can be prepared by introducing appropriate nucleotide changes into a nucleic acid encoding the oleosin, or by in vitro synthesis of the desired protein. Such mutants include, for example, deletions, insertions or substitutions of residues within the amino acid sequence. A combination of deletion, insertion and substitution can be made to arrive at the final construct, provided that the final protein product possesses the desired characteristics. The production and identification of functional mutants of naturally occurring oleosins is also well within the capability of those skilled in the art.

Also included within the scope of the invention are proteins which are differentially modified during or after synthesis, e.g., by biotinylation, benzylation, glycosylation, acetylation, phosphorylation, amidation, derivatization by known protecting/blocking groups, proteolytic cleavage, linkage to an antibody molecule or other cellular ligand, etc.

Olesoins may be prepared using techniques known the art or using a method of the invention. In one embodiment, olesoins are prepared in as a crude extract by

1) adjusting the pH of the extract to a pH of at least about 11.5,

2) separating 1) to produce a solid and liquid phase and selecting the liquid phase,

3) reducing the pH of the liquid phase to precipitate the proteins,

4) separating 3) to produce a solid and liquid phase and selecting the solid phase, and

5) dispersing the solid phase in a carrier.

In an alternate embodiment, filtration methods are used to at least partially purify oleosin from plant material.

### Surfactants

Artificial oil bodies of the invention comprise one or more surfactants.

The surfactant may be a non-ionic or anionic surfactant or a combination of two or more thereof. More particularly, the surfactant may be anionic, cationic, zwitterionic or a combination of two or more thereof. For example the surfactant may be selected from the group consisting of, but not limited to, phospholipid, monoglyceride, Perfluorooctanoate (PFOA or PFO), Perfluorooctanesulfonate (PFOS), Sodium dodecyl sulfate (SDS), ammonium lauryl sulfate, and other alkyl sulfate salts, sodium laureth sulphate, also known as sodium lauryl ether sulfate (SLES), Alkyl benzene sulfonate, Soaps, or fatty acid salts, Cetyl trimethylammonium bromide (CTAB), hexadecyl trimethyl ammonium bromide, and other alkyltrimethylammonium salts, Cetylpyridinium chloride (CPC), Polyethoxylated tallow amine (POEA), Benzalkonium chloride (BAC), Benzethonium chloride (BZT), Dodecyl betaine, Cocamidopropyl betaine, Coco ampho glycinate, Alkyl poly(ethylene oxide), Alkylphenol poly(ethylene oxide), Copolymers of poly(ethylene oxide) and poly(propylene oxide) (commercially called Poloxamers or Poloxamines), Alkyl polyglucosides, including Octyl glucoside, Decyl maltoside, Fatty alcohols, Cetyl alcohol CA), Poly(vinyl alcohol) (PVA), Oleyl alcohol, Cocamide MEA, cocamide DEA, Polysorbates such as Tween 20, Tween 40, Tween 80, and Dodecyl dimethylamine oxide.

In one embodiment, the surfactant is a phospholipid. However, when the fatty acid is not a polyunsaturated fatty acid with at least four double bonds a preferred embodiment is that the artificial oil body comprises no phospholipid or phospholipid is present with at least one other surfactant (for example, the at least one other surfactant comprises at least 5%, or at least 25%, or at least 50%, or at least 75%, or at least 90%, of the total surfactant in the artificial oil body).

Phospholipids are a class of lipids and are a major component of all cell membranes as they can form lipid bilayers. Most phospholipids contain a diglyceride, a phosphate group, and a simple organic molecule such as choline. One exception to this rule is sphingomyelin, which is derived from sphingosine instead of glycerol.

Examples of phospholipids useful for the invention include, but are not limited to, phosphatidylethanolamine, phosphatidylcholine, lecithin, phosphatidylserine, phosphatidylglycerol, phosphatidylinositol and mixtures of two or more thereof.

Phospholipids for production of oil bodies of the invention may be from various sources, for example, from seeds, and more typically from the oilseeds. These include lecithin and lyso-lecithin. The lecithin may, for example, be obtained from soy (soy lecithin) or sunflower (sunflower lecithin). Additionally, phospholipids with a modified fatty acid composition can be used. Such phospholipids can be, for example, enzyme modified soy phospholipids. Enzyme modified phospholipids may be prepared, for example, from soy phospholipids (SLP; True Lecithin, Mie, Japan) by treatment with phospholipase A₂ (Novo Industry, Bagsvaerd, Denmark). Additionally, phospholipids with a modified fatty acid composition can be obtained from plants or plant seeds that have been genetically modified to produce phospholipids with modified fatty acid compositions. An example of a phospholipid with a modified fatty acid composition is lecithin with a modified fatty acid composition. Other methods that are well known in the art may also be used to modify the fatty acid compositions of phospholipids.

The surfactant layer surrounding the lipid core of the oil body usually is a monolayer.

Any concentration of the surfactant can be used which allows the formation of the artificial oil bodies.

### Artificial Oil Bodies

An used herein, the term “artificial oil body” refers to a structure, typically between about 0.1 and about 100 μm in size, comprising oil surrounded by a surfactant layer with oleosins embedded in the surfactant layer. They are referred to as artificial because there is no evidence that the oil bodies of the invention exist in nature. Nonetheless, an “artificial oil body” of the invention can also be referred to as an “oil body”.

Typically, an artificial oil body of the invention comprises about 90% to about 98.5% glyceride, about 0.2% to about 5% surfactant, and about 0.5% to about 5% protein. For example, a typical artificial oil body of the invention comprises an oil/surfactant/oleosin ratio of approximately 97.5/1.0/1.5. As shown herein, reducing the concentration of oleosin results in increased size of the oil body.

In an embodiment, at least 10%, more preferably at least 20%, more preferably at least 30%, of the fatty acids are polyunsaturated fatty acids with four or more double bonds. For example, Hi-DHA tuna oil produced by Numega has about 37% PUFAs, whereas algal oil DHASCO produced by Martek has about 61% PUFAs.

In another embodiment, at least 10%, more preferably at least 20% of the fatty acids are DHA. For example, Hi-DNA tuna oil produced by Numega has about 26% DHA, whereas algal oil DHASCO produced by Martek has about 40% DHA.

The oil bodies can be obtained by preparing a pre-emulsion by mixing oil, surfactant and oleosin with water (for example) using an automatic stirrer operated at 800 rpm for 30 minutes. Advantageously, the oleosins can be provided as a protein extract from plants obtained using a method of the invention. In an embodiment, the oleosin is stored as a powder, for example as produced by freeze drying, before being used in the methods of the invention.

Artificial oil bodies of the invention are oxidatively stable. For example, less than 40%, more preferably less than 30%, more preferably less than 20%, and even more preferably less than 15%, of the fatty acids, such as total concentration of EPA and DHA, in the artificial oil bodies are depleted when the oil bodies are stored at 40° C. for 15 days. In another example, following storage at 40° C. for 15 days, the oil bodies comprise less than 6, more preferably less than 5, and even more preferably less than 4 μg/ml trans,trans-2,4-heptadienal. In yet another example, less than 90 meq/kg oil, more preferably less than 50 meq/kg oil, more preferably less than 25 meq/kg oil, of hydroperoxides are produced after 5 days at 40° C.

### Products Comprising Artificial Oil Bodies and Uses Thereof

The oil bodies can be used in a wide variety of products. Examples of such products include, but are limited to, a food or feed product, a drink product, a personal care product, a pharmaceutical product or an industrial product. Processes for the production of these products are well known in the art.

In one preferred embodiment, the subject invention is directed to products which may be ingested by animals and/or humans. Since, these compositions may be ingested they must be of food grade quality. The particular product and the particular form in which the oil bodies are applied, however, is not of critical importance and may be as desired. Examples of a food, feed or drink product, include, but are not limited to, a non-dairy substitutes, a non-dairy cheese, a non-dairy yoghurt, a margarine, a mayonnaise, a vinaigrette, an icing, cream, soup, ice creams (for example as a stabilsation agent), a salad dressing, a mustard, a candy, bechamel sauce, chewing gum, a pudding, a baking product, a condiment, a juice (for example as a naturally clouding agent), baby formula, a flavour carrier, a texturing agent, fish food, petfood and livestock feed.

Examples of a personal care product include, but are not limited to, a soap, a cosmetic product, a skin cream, a facial cream, a tooth paste, a lipstick, a perfume, make-up, a foundation, a blusher, a mascara, an eyeshadow, a sunscreen lotion and a hair care product.

Examples of a pharmaceutical product include, but are not limited to, a therapeutic agent, a diagnostic agent and a delivery agent.

The therapeutic or diagnostic agent can be molecule that one wishes to deliver to a host. In one embodiment, the active ingredient may be a protein or peptide that has therapeutic or diagnostic value. Such peptides include antigens (for vaccine formulations), antibodies or antibody-related molecules, cytokines, blood clotting factors and growth hormones.

Examples of an industrial product include, but are not limited to, a paint, a coating, a lubricant, a film, a gel, a drilling fluid, paper sizing, a latex, a building or road construction material, an ink, a dye, a wax, a polish and an agrochemical formulation.

Artificial oil bodies of the invention can be used to treat or prevent diseases due to the well known benefits of the fatty acids in the oil bodies of the invention. Thus, in a further aspect, the present invention provides a method of treating or preventing a condition which would benefit from fatty acids, in particular a condition which benefits from polyunsaturated fatty acids with four or more double bonds, the method comprising administering to a subject with the condition one or more oil bodies of the invention and/or a composition of the invention. Examples of such conditions include, but are not limited to, cardiac arrhythmia's, angioplasty, inflammation, asthma, psoriasis, osteoporosis, kidney stones, AIDS, multiple sclerosis, rheumatoid arthritis, Crohn's disease, schizophrenia, cancer, foetal alcohol syndrome, attention deficient hyperactivity disorder, cystic fibrosis, phenylketonuria, unipolar depression, aggressive hostility, adrenoleukodystophy, coronary heart disease, hypertension, diabetes, obesity, Alzheimer's disease, chronic obstructive pulmonary disease, ulcerative colitis, restenosis after angioplasty, eczema, high blood pressure, platelet aggregation, gastrointestinal bleeding, endometriosis, premenstrual syndrome, myalgic encephalomyelitis, chronic fatigue after viral infections or an ocular disease.

In an embodiment, the oil bodies or composition is provided by oral administration. Typically, the oil bodies are administered in an amount that is sufficient to deliver at least 10 mg of fatty acid such as omega-3 PUFA per administration event. More preferably, at least 30 mg, even more preferably at least 50 mg and most preferably at 100 mg of fatty acid such as omega-3 PUFA is delivered per administration event.

It will be understood that the present invention may suitably be employed to treat animals, such as mammals. Most preferably, the present invention is used to treat humans.

In a preferred embodiment, the product is, or comprises, an oil-in-water emulsion. Such emulsions of the invention are physically and oxidatively stable, and do not coalesce on standing.

The oil bodies may be formulated into an emulsion using techniques known in the art. Preferably, at least one additional ingredient is added to the oil body preparation. The additional ingredient may be added as a solution, suspension, a gel or solid and quantities of the additional ingredient will depend on the formulation. The additional ingredient may upon formulation become associated with the oil bodies, remain suspended in solution, or form a suspension in which the oil bodies are dispersed. The ingredient may also penetrate the surfactant layer surrounding the oil body. Ingredients which may penetrate the oil body include oils, waxes and the colorant Nile Red. In a preferred embodiment, the additional ingredient is a liquid phase. In a further preferred embodiment the liquid phase is water.

Water may be added either directly or through moisture associated with another ingredient. The final amount of water is not critical, as long as upon mixing of the ingredients, a stable emulsion is formed. Generally, the compositions will contain at least 1% of water and up to 99% water. Usually mixing will be required to provide an adequate emulsion and it may be necessary to apply heat or pressure.

In another preferred embodiment, the additional ingredient is an oil or a wax. Oils or waxes may partition within the oil bodies and in this manner lipid soluble ingredients, such as lipid soluble vitamins may be delivered to the oil body. Where oils or waxes comprise the added ingredient, the oil bodies may remain suspended in the lipophilic phase or double emulsions may be formed.

The final compositions may be in solid or in liquid form or of any other desired viscosity. The emulsion may be thickened using gelling agents such as cellulose and derivatives, Carbopol and derivatives, carob, carregeenans and derivatives, xanthane gum, sclerane gum, long chain alkanolamides, and bentone and derivatives, typically present in concentrations less than 2% by weight.

The emulsion may further comprise surfactants to wet, foam, penetrate, emulsify, solubilize and or disperse a selected material. For example anionic surfactants such as sodium coconut monoglyceride sulphonate, cationic surfactants, such as lauryl trimethyl ammonium chloride, cetyl pyridinium chloride and trimethylammonium bromide, nonionic surfactants including pluronics, and polyethylene oxide condensates of alkyl phenols, and zwitterionic surfactants such as derivatives of aliphatic quaternary ammonium, phosmomium and sulphonium compounds may all be added as required.

Chelating agents, capable of binding metal ions, such as tartaric acid, EDTA, citric acid, alkali metal citrates, pyrophosphate salts or anionic polymeric polycarboxylates may be also included in the emulsion formulation as desired.

Generally, the emulsion formulations will be treated such that contamination by bacteria, fungi, mycoplasmas, viruses and the like or undesired chemical reactions, such as oxidative reactions are prevented. In preferred embodiments this is accomplished by the addition of preservatives, for example sodium metabisulfite or other chemical additives or by irradiation, for example by ionizing radiation such as cobalt-60 or cesium-137 irradiation or by ultraviolet irradiation.

In addition, active agents may be added. For example, cosmetic compositions may be formulated as stable suspensions using the present emulsion formulation and vitamins and moisturizing agents may be included in skin creams. One particularly advantageous way in which an active ingredient may be included in emulsions of the subject invention, is through construction of oleosin gene fusions as detailed in WO 96/21029. These fusion proteins are created by genetically linking the gene encoding oleosin to a gene encoding a peptide or protein of interest. Expression of the fusion gene, in for example an oilseed plant, results in synthesis of a fusion protein which is then used to produce artificial oil bodies of the invention. In principle any desired protein or peptide may be produced using this technology, including polar fish antifreeze peptides or a therapeutic protein may be produced as an oleosin fusion.

An emulsion with film forming properties may also be formulated. Such an emulsion when it is applied to a surface and dried forms a coating. An example of an emulsion where a coated oil body film is applied is in fish food, where oil bodies (for example produced from microalgae oil) may be applied to the fish food to enhance the dietary value. A film forming emulsion is particularly useful in embodiments of the present invention where controlled release of an active ingredient is desirable such as in delivery of pharmaceuticals or volatiles such as fragrances. The release time of the active agent from a film of emulsion, which occurs during drying, depends, among other factors, on the thickness of the film. When a thicker coating is applied a longer drying time will result in a slower release of the active agent. In variant contemplated formulations, release of the agent occurs only when the film is dry.

Other factors, such as the composition of the emulsion and the type and concentration of the active ingredient also determine the characteristics of release. For example, cosolvents, such as ethanol, may be included in the formulation and influence the release time. Release of an active ingredient is also desirable in food applications, where a flavorant entrapped in an emulsion is released during consumption. The release of the flavorant, depending on the exact formulation of the emulsion, may elicit a sudden intense sensation or a more subtle blend of flavours and essences.

The emulsion formulation may also be used in sprays and aerosols. Volatiles, such as alcohol and fragrances may be included in these sprays. Emulsions of this type may also be sprayed onto the surface of dried food preparations such as potato chips and dried soup. The emulsion might include a flavorant and add preservative value or assist in maintaining the appropriate moisture levels of the food.

The stability of the present emulsion formulation may be exploited in formulations of acid emulsions. For example, the emulsion formulation may be used in the preparation of a mayonnaise-like food product, which besides the oil body preparation comprises a vegetable oil, mustard, vinegar and egg yolk, if desired. Pourable emulsions, such as salad dressings may be prepared by increasing the relative amount of vinegar and/or by the addition of water.

An example of an application where heat may be applied without apparent deleterious effects, is in the preparation of a savory sauce such as a bechamel sauce or in sweet sauces such as chocolate sauces. In these applications, the oil body preparation is employed as a frying substitute. To prepare a bechamel sauce, to 1 part of the heated oil body preparation, 1 part (w/w) of flour is added and stirred until a thick suspension is formed. At moderate heat milk is gradually added until a sauce with a desired viscosity is obtained.

The emulsion formulation may also be used as a butter substitute. In this application, small amounts of water are added to the oil body preparation, for example, less than 10% until a desired viscosity is obtained. Natural butter flavours and thickeners may be added as desired. The butter substitute may be used on sweet corn, bread, in cake mixes or bread making. Salt, which contributes flavour and acts as a preservative may be added typically to a level of about 2.5% (wt/vol). Colour agents, for example, extracts of annatto seed or carotene may be added to deepen the colour as desired. An advantage of this application is that the oil body based butter does not comprise hydrogenated fatty acids, which are used in the formulations of margarines and the like to achieve a desirable consistency, but are also with associated with cardiovascular diseases.

Shortenings may be prepared to various degrees of stiffness, from a foam to a pourable shortening. In this application, air is beaten into the emulsion formulation and the emulsion formulation can be considered to be dispersed into the continuous phase, air. Shortenings may be applied to mixes where creaming and fluffing are desired. These mixes include icings, synthetic creams, ice creams and cake batter.

An imitation fruit juice may be prepared from artificial or natural flavours and nutrients. Such imitation juices do not have the correct appearance and due to transparency appear to be weak or diluted. By adding a small amount, for example 0.1 to 1% (v/v) of the oil body preparation or an emulsion thereof clouding may occur to give the juice a rich appearance. Thus the present oil body preparation may be used as a clouding agent. In another application involving juices, the oil body preparation or an emulsion thereof may be added to juices with settleable solids, such as tomato juice.

Adding a small amount of the oil body preparation, for example 0.1 to 1% (v/v), may decrease the rate of settling of the solids in the juice and assist in maintaining the rich appearance.

Topical applications of the oil body preparation of the present invention are also envisaged. In this embodiment the emulsion is formulated as a dermatologically acceptable emulsion, which may for example be employed to moisturize facial and/or body skin, including nails and lips or may have properties to combat ageing of the skin, acne, pigmentation, hair loss, or promote hair removal or facilitate wound healing and/or restructuring of the skin tissue. The oil body preparation represents preferably 1-99% by weight of the final composition.

The cosmetic compositions of the present invention may comprise additional hydrocarbon compounds such as plant, animal, mineral or synthetic oils or waxes or mixes thereof. They comprise paraffin, petrolatum, perhydrosqualene, arara oil, almond oil, calphyllum oil, avocado oil, sesame oil, castor oil, jojoba oil, olive oil, or cereal germ oil.

Esters may be included such as esters of lanolic acid, oleic acid, lauric acid, stearic acid, myristic acid. It is also possible to include alcohols for example, oleoyl alcohol, linoleyl alcohol or linolenyl alcohol, isostearyl alcohol or octyl dodecanol, alcohol or polyalcohol.

Further hydrocarbons which may be included are octanoates, decanoates, ricinoleates, caprylic/capric triglycerides or C10 to C22 fatty acid triglycerides. Addition of these agents may result in the formation of double emulsions.

Hydrogenated oils, which are solid at 25° C., such as hydrogenated castor oil, palm oil or coconut oil, or hydrogenated tallow; mono- di- tri- or sucroglycerides; lanolins; and fatty acids which are solid at 25° C. may also be included in the cosmetic formulations of the present invention. Among the waxes which may be included are animal waxes such as beeswax; plant waxes such as carnauba wax, candelilla wax, ouricurry wax, Japan wax or waxes from cork fibres or sugar cane; mineral waxes, for example paraffin wax, lignite wax, microcrystalline waxes or ozokerites and synthetic waxes.

Pigments may be included and may be white or coloured, inorganic or organic and/or paerlescent. These pigments comprise titanium dioxide, zinc oxide, ziriconium dioxide, black, yellow, red and brown iron oxides, cerium dioxide, chromium oxide, ferric blue, carbon black, barium, strontium, calcium and aluminum lakes and mica coated with titanium oxide or with bismuth oxide.

Active ingredients commonly employed in skin creams, such as vitamins, for example as vitamin A or C and alpha hydroxy acids, such as citric, glycolic, lactic and tartaric, into cosmetic and/or dermatological compositions may be included. For example, U.S. Pat. No. 5,602,183 teaches that vitamin C or ascorbic acid promotes growth of connective tissue, particularly in the skin strengthens the skin against external aggressions such as from smoke and UV radiation. Moisturizing agents which may be included in skin creams and cosmetics are for example mineral oil and urea. Antioxidants such as the naturally occurring tocopherols and polyphenols, or butylated hydroxytoluene and hydroxyanisole may also be also added. Sunscreens such as octyl methoxycinnamate (Parsol MCX), 3-benzophenone (Uvinul M40) and butylmethoxydibenzoylmethane (Parsol 1789) may be employed to prepare a sun tanning lotion. Pharmaceutically active ingredients which may be used to formulate cosmetic compositions include for example antibiotics, fungicides and ant-inflammatory agents.

The final cosmetic product may be in the form of a free, poured or compacted powder (foundation, blusher or eyeshadow), a relatively greasy product such as lipstick, mascara, or an oil or lotion for the body or face.

The oil body preparation may also be used to serve as an orally acceptable carrier in toothpaste which may further comprise silicas, surfactants, chelating agents, a fluoride, thickeners, sweeteners, flavorants, for example as oil of peppermint, enzymes and biocides.

An example of an industrial product which may be formulated is paint wherein the main resin, such as those based on silicone type compounds, acrylic compounds, polyester, akyd, fluorine, epoxy, polyurethane may be partly or entirely replaced by the oil body preparation of the present invention. Further additives such as pigments, dyes, glass flakes, and aluminum flakes, pigment dispersants, thickeners, levelling agents, hardening catalysts, hardening agents such as dioisocyanates, hardening catalysts, gelling inhibitors, ultraviolet absorbing agents, free radical quenching agents. etc. may be formulated in paint compositions as required.

The oil body preparation may also be to formulate lubricants. For example, the oil body preparation may be used to partially or entirely replace the lubricating oils such as animal oils, vegetable oils, petroleum lubricating oils, synthetic lubricating oils, or the lubricating grease such as lithium grease, urea grease and calcium grease. Other compositions employed in a lubricant formulation comprise antioxidants, detergent dispersants, oilness agents, friction modifiers, viscosity index improvers, pour point depressants, solid lubricant material, rust inhibitors and antifoamers.

Waxes may also be prepared using the oil body preparation of the present invention. These comprise rinse-wax types, such as those providing a stable hydrophobic film-finish onto automobiles and other protective coatings. Other compositions used in the preparation of a wax comprise surfactants, mineral oils, such as mixed paraffinic and aromatic/naphtenic oils, perfumes, biocides, colouring agents which may be added in compatible amounts as desired.

### EXAMPLES

### Example 1

### Materials and Methods

### Materials

Canola (Brassica napus) seed, oil, and meal were gifts by Cargill Australia. The meal was the residue after canola oil extraction by the usual industrial process of mechanical expelling followed by solvent extraction. On arrival, the seeds were sieved to remove straw and other non-seed material and stored at 4° C. until required. The seeds contained 38.0% oil (information provided by Cargill, Ltd) and 25.2% proteins as determined by LECO® FP-2000 analysis. Canola oil was of refined, bleached and deodorized grade, and had TBHQ (200 ppm) antioxidant added. Winterized tuna oil (HT303-4) was obtained from LYSI HF (Reykjavik, Iceland).

### Extraction of Oil Canola Bodies

Natural oil bodies were extracted from canola seeds according to the method described of Tzen (1993) with the exception that the final hexane washing step was omitted. In brief, the seeds were soaked in sodium phosphate buffer (pH 7.5) overnight and homogenized with the grinding medium (10 g dry seeds per 50 ml) for 40 seconds using a kitchen blender (Sunbeam Multiblender, 650W). The grinding medium contained 0.6 M sucrose and 10 mM sodium phosphate buffer (pH 7.5). The homogenate was filtered through three layers of cheesecloth. The filtrate was placed in centrifuge tubes, an equivalent amount of flotation medium (grinding medium containing 0.4 M instead of 0.6 M sucrose) was layered on top, and the tubes were centrifuged at 5,000 g for 60 min at 10° C. in a swinging-bucket rotor (Beckman J6-HC).

The oil bodies collected at the top were resuspended in twice their volume of detergent washing solution containing 0.1% Tween-20, 0.2 M sucrose, and 5 mM sodium phosphate buffer pH 7.5. The re-suspension was placed at the bottom of centrifuge tubes and 10 mM sodium phosphate buffer pH 7.5 was layered on top in the ratio 1:1, and the tubes were centrifuged. The oil bodies on top were collected and resuspended in twice their volume of ionic elution buffer (grinding medium additionally containing 2 M NaCl). The suspension was placed at the bottom of centrifuge tubes, floating medium (grinding medium containing 2 M NaCl and 0.25 M instead of 0.6 M sucrose) was layered on top (ratio 1:1), and the tubes were centrifuged. The oil bodies on top were collected and resuspended in their volume of 9 M urea. The re-suspension was vigorously shaken at room temperature for 10 min, then placed at the bottom of centrifuge tubes, 10 mM sodium phosphate buffer pH 7.5 was layered on top (ratio 1:1); and the tubes were centrifuged. The oil bodies on top were collected and resuspended in their volume of grinding medium. The resuspension was placed at the bottom of centrifuge tubes, flotation medium was layered on top (ratio 1:1), and the tubes were centrifuged. The oil bodies on top were collected and resuspended with grinding medium to give a concentration of about 100 mg/ml.

Isolation of Oleosin from Canola Oil Bodies

Oleosin was extracted from the purified canola OBs dried to 14% (w/w) moisture content. The oil body preparation was redispersed in a solution of deionised water and ethanol (60% ethanol) and stirred for 1 h, and the ethanol was removed using a rotary evaporator (BÜCHI Rotavapor R-124). The emulsion was then centrifuged at 5,000 g for 30 min in a swinging-bucket rotor at 20° C. (Beckman J6-HC). The top layer containing water and traces of ethanol was removed and the proteins redispersed in deionised water at a concentration of 100 g/L. This aqueous protein dispersion was stored at −18° C. until required.

### Protein Characterisation

The proteins isolated from canola oil bodies (COBs) were characterised according to their molecular weight by electrophoresis. The electrophoresis was performed using NuPAGE® gel 4-12% BT 1.0 gel (NuPAGE® invitrogen) according to supplier's recommendations. In brief, the concentration of protein samples was adjusted to 1 mg/ml and 25 μl placed in eppendorf tubes. Then, 10 μl of NuPAGE® LDS sample buffer (4×) and 5 μl of NuPAGE® reducing agent (10×) were respectively added and the tubes centrifuged for 3 seconds at 14,000 rpm at room temperature (Eppendorf Centrifuge 5415C) before being heated to 70° C. for 10 minutes. Markers (Mark 12™ Unstained Standards) were prepared the same way except that their concentrations were not adjusted. Finally, 10 μl amounts of both markers and samples were added to the gel already placed in an electrophoresis cell (Novex Mini-Cell, Invitrogen) containing NuPAGE® Running Buffer and anti-oxidant. The cell was connected to a generator (BIORAD Power Pac 300) set at 200 Volts and 400 milliampers for 35 min.

Once the electrophoresis was complete, the gel was washed 3 times in deionised water and placed in a plastic container with SimplyBue™ SafeStain (Invitrogen) for 2 h under slow agitation, 42 rpm (RATEK Platform Mixer model OM6). Afterwards, the gel was washed twice more with deionised water and placed in deionised water for 2 hours in order to remove non-protein bound stain, and photographed with a G:BOX (SYNGENE) and the GeneSnap 7.07 software (SYNGENE).

Extraction of Oleosin from Canola Meal

Oleosin was extracted from canola meal according to a modification of the procedure of Ghodsvali et al. (2005). In brief, canola meal (1.0 kg) was soaked in deionised water (10.0 L) and the pH adjusted to 12.0 with aqueous sodium hydroxide (5%, w/w) and mixed for 10 minutes using an Ultraturax mixer. After standing for 10 minutes, the contents were mixed for a further 10 minutes. The resulting slurry was centrifuged at 4,000 g in a swinging-bucket rotor for 30 min at 20° C. (Beckman J6-HC). The pH of the supernatant containing crude protein adjusted to pH 6.5 (isoelectric point of oleosin) when protein precipitation occurred. The stirring was continued for a further 30 min before centrifuging at 4,000 g when the supernatant and the precipitate were recovered. The precipitate was washed with pH 6.5 water using Ultraturax and centrifuged again for 30 min at 4,000 g. The washed precipitate was recovered as a paste and stored in the wet form at −18° C. until required.

### Construction of Artificial Oil Bodies

In initial experiments artificial oil body dispersions containing canola oil and tuna oil, respectively, were prepared using oleosin extracts variously obtained from canola meal, both in the presence and absence of phospholipid. First, a pre-emulsion was prepared by mixing oil and water containing the proteins using an automatic stirrer (RZR 2051 Control from Heidolph) operated at 800 rpm for 30 minutes. When phospholipids were included, they were dissolved in the oil prior to emulsification. The weight ratios of the ingredients used resembled their ratios in natural canola OBs. Thus, the preemulsions contained 1.5% of proteins, 1% of phospholipids if required, and 10% of oil in order to achieve a particle size between 0.5 and 2 μm and oil droplets well covered by proteins and phospholipids. The pre-emulsion was homogenized (RATEK Pilot Lab Homogenizer) three times at 500 bars.

In later experiments artificial oil body dispersions containing canola oil and tuna oil, respectively, were prepared using surfactants and oleosin extracts variously obtained from canola meal. When phospholipids or other surfactants were included, they were mixed with the oil prior to emulsification. First, the pH of the oleosin extract was adjusted to approximately 8.0 by dropwise addition of 40% aqueous sodium hydroxide while being subject to Ultraturax mixing. Oil (10 g), oleosin extract (1.5 g), surfactant (various) and deionized water (87.5 g) were placed in a glass beaker and warmed in a water bath (60° C.) before being mixed for 2 min using a Silverson mixer under a blanket of nitrogen to minimize oxidation. The mixture was homogenized (EmulsiFlex C5) twice at 1000 bar under nitrogen. The weight ratios of the ingredients used resembled their ratios in natural canola OBs. Thus, the preemulsions contained 1.5% of proteins, 1% of surfactant if required, and 10% of oil.

The oleosin extract from canola meal was “worked up” prior to emulsion preparation as follows. The stored extract was allowed to thaw and mixed using an Ultraturax mixer 40% (w/W) while adding sodium hydroxide dropwise until the pH reached 8.0.

### Preparation of Control Emulsions Using Tween40 Emulsifier

10% (w/w) o/w emulsions were prepared with canola and tuna oils using Tween40 (6%, w/w) as the emulsifier. Emulsification was performed as above.

### Physical Characterisation of Artificial Oil Bodies

The physical stability of the AOBs was studied over 12 days at 4° C., ambient temperature (approx. 20° C.), 45° C. and 60° C. respectively, respectively. Particle size of the emulsions was measured with a MASTERSIZER 2000 (Malvern) using a Malvern Small Volume Sample Presentation Unit combined with a Hydro 2000 g module. (particle RI: 1,456/absorption: 0.001/dispersant RI: 1.330 water). Light microscopy photos were obtained with a light microscope Olympus BH-2 linked to a Color View IIIu camera and processed using AnalySIS getIT 5.0 software. Aggregation of particles was examined by treatment with sodium dodecyl sulfate (SDS). This was performed by mixing three volumes of the emulsion with one volume of a 10% (w/w) solution of SDS for 10 min using a magnetic stirrer at room temperature followed by reanalysis.

Oxidative Stability of Oil in Water Emulsions Prepared from Oil Bodies

The oxidative stability of the AOB dispersions were evaluated from the depletion of EPA/DHA, as well as the amount of trans, trans-2,4-heptadienal produced during storage under accelerated oxidation conditions. For the latter purpose samples (2 g) of the emulsions were placed headspace vials (10 ml) and sealed with silicone-lined aluminium caps, and heated at 40° C. or 60° C. inside a dark oven over 15 days. Samples were withdrawn daily and immediately analyzed for 2,4-heptadienal by solid phase micro extraction and gas chromatography-mass spectrometry as below.

Oxidative volatile compounds generated during the accelerated oxidation of AOB emulsions were determined by headspace solid phase micro extraction (SPME) using a DVB/CAR/PDMS fiber, (50/30 μm, Supelco, Sydney, Australia). The fiber was inserted into the sample headspace and the vials were incubated at 60° C. for 15 min and then withdrawn and transferred to the GC injector (operated in the splitless mode) and held for 7 min to desorb the extracted volatile compounds into the GC column. The entire series of events was performed using a Combi PAL Auto Injector (CTC Analytics, Zwingen, Switzerland). GC-MS was performed using an Agilent Model 6890 GC and Model 5973 MSD (Palo Alto, Calif.) fitted with a VOC fused silica capillary column (60 mm, 0.32 mm i.d., 0.18 mm film thickness, Agilent, Melbourne, VIC, Australia). The GC oven was programmed from 40° C. increasing to 220° C. at the rate of 22° C. min−1 and held at that temperature for further 14 minutes. Helium was used as the carrier gas at a constant flow rate of 2.0 mL min−1. The injector was initially operated in the splitless mode and then switched to the split mode (1:20) 2 min after sample injection. The temperature of the injector and the MS detector were both held at 230° C. The MS was operated in scan mode (29-350 amu). Data analyses were performed using Chemstation software and compounds were identified by standards as well as reference to a library of spectra (Wiley 275). Volatile compounds in the emulsions were quantified by using calibration curves established from their corresponding fresh emulsions added with different levels of volatile compound 2,4-heptadienal (trans, trans) standards.

Depletion of ALA (canola) EPA and DHA (tuna) during storage was measured by fatty acid analysis using capillary gas chromatography. For this purpose lipids were extracted from the stored emulsions using iso-propanol/hexane and converted to methyl esters by potassium hydroxide catalysed transesterification prior. The esters were analysed on a BPX-70 capillary column and detected by flame ionisation detection.

### Example 2

### Extraction of Oleosin from Canola Meal

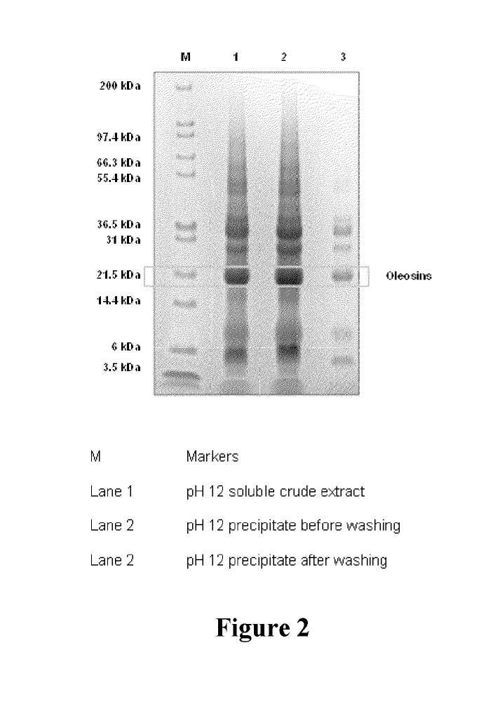

FIG. 2 shows electrophoresis results for the protein isolated from canola meal by alkaline extraction (pH 12) followed by precipitation at pH 6.5 and water washing. The molecular weight of oleosin has been reported to in the range 18-20 kDa, and the above isolate contained significant amounts of protein in this molecular range confirming the presence of oleosin. Precipitation of protein at different pH values in the range 3.0-12.0, and subsequent electrophoresis showed that the maximum oleosin recovery was obtained at pH 6.5. Previous studies by other workers have focussed on isolation of oleosin from pre-extracted oil bodies after they have been destabilised by treatment of ethanol or mixtures of chloroform and methanol. To the best of our knowledge, no attempts have been made previously to isolate oleosin from oilseed or meal by aqueous extraction. This could be because oleosins are considered insoluble in water regardless of the pH (Beisson et al., 2001). The apparent water insolubility could be the result of the tendency of oleosin to agglomerate on drying; and once this happens it is hard to dissolve or disperse oleosin in water.

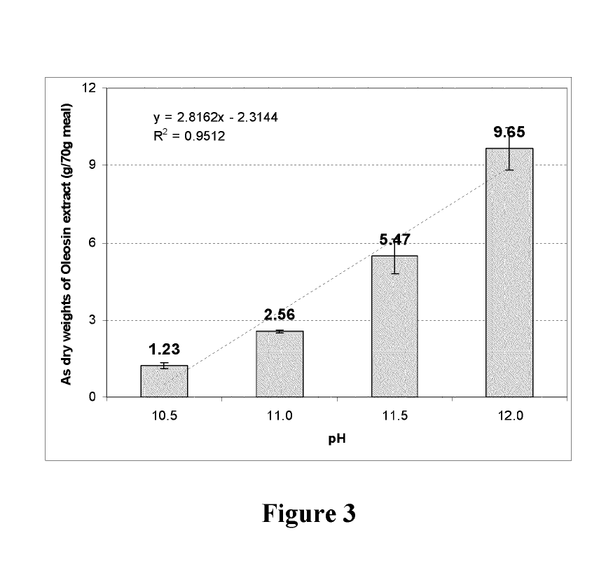

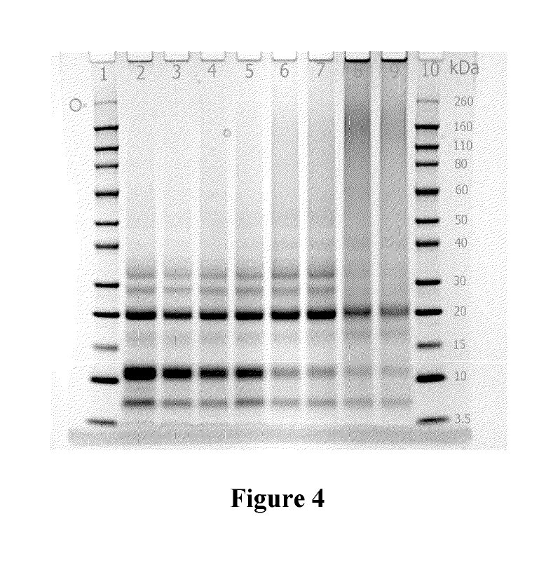

Following the initial experiments, optimisation of extraction of oleosin from canola meal was conducted. The highest oleosin yield was obtained at pH 12.0 with significantly lower recoveries obtained as the pH was reduced (FIG. 3). pH 12.0 also furnished the purest oleosin extracts as shown by SDS-PAGE (FIG. 4). Lower pH values tended to extract increasing amounts of two lower molecular weight components of approximately 12 and 5 kDa.

### Example 3

### Particle Size of Artificial Oil Bodies

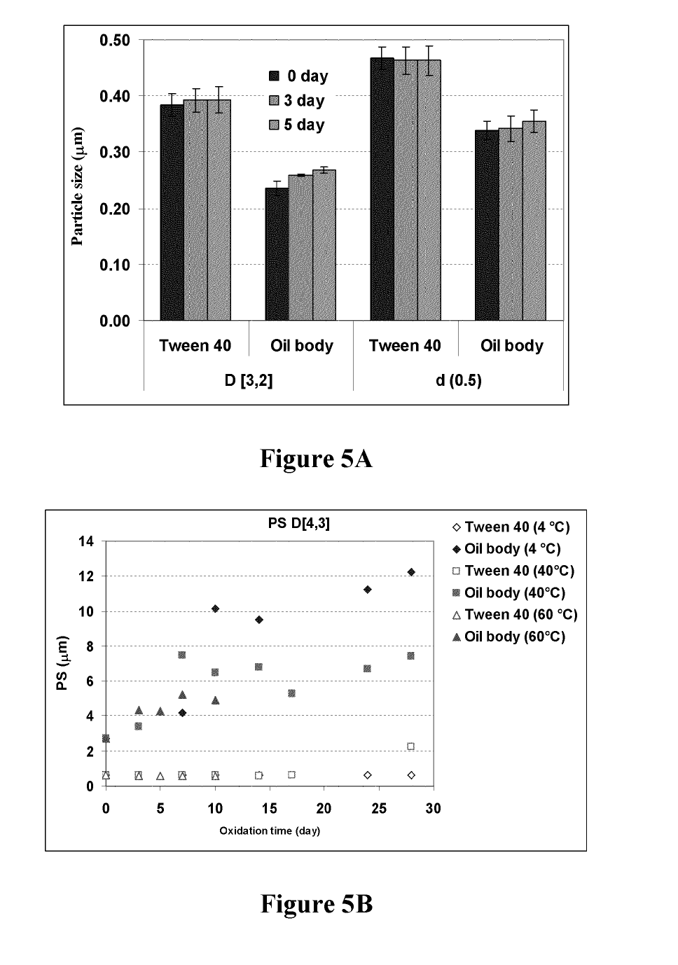

To eliminate any effects of particle size on the rate of oxidation, the particle size of the two emulsions (Tween40 and oleosin) were matched as far as possible (FIG. 5). It was also important to ensure that no separation occurred and the particle size remained relatively constant during storage for the accelerated oxidation study. The droplet size of AOBs made with oleosin as well as that of the Tween40 emulsion remained unchanged during storage over 12 days at 60° C. The uniformity of droplet size during storage at elevated temperatures enabled accelerated oxidation studies based on headspace analysis.

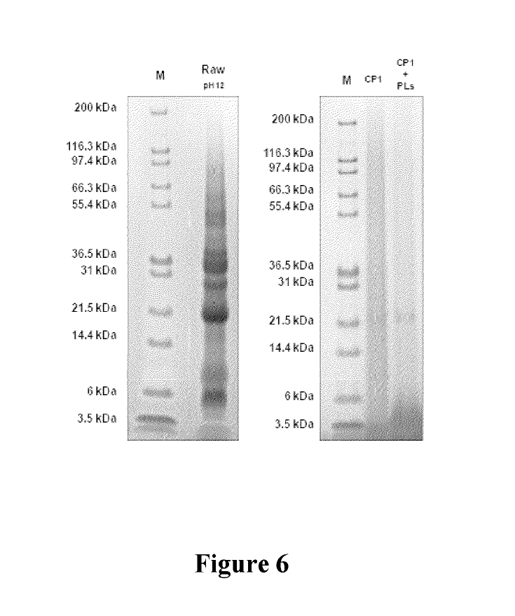

Clearly, the pH 12-soluble extract was primarily composed of cellular protein. The fraction precipitated also would have contained relatively large amounts of non-oleosin protein. Interestingly, however, when AOBs were prepared using either the pH 12-soluble extract or the pH 6.5-precipitated protein re-solubilised at pH 12, there appeared to be a natural selection of oleosin to form the oil body surface (FIG. 6). This will have the advantage of not requiring further purification of the precipitated protein to enhance the oleosin content prior to preparation of AOBs.

### Example 4

### Oxidative Stability

The oxidative stabilities of aqueous dispersions of canola and tuna oil AOBs prepared with re-solubilised pH 6.5 precipitated protein both in the absence and presence of PL were compared with a equivalent emulsions prepared with the corresponding oil and Tween40 emulsifier. For this purpose, the emulsions were stored at an elevated temperature (60° C.) and the oxidation levels were measured by three different methods, i.e. primary oxidation products (hydroperoxides), secondary oxidation products (trans,trans-2,4-heptadienal), and depletion of unsaturated fatty acids (linolenic acid for canola and DHA for tuna oil). The hydroperoxide levels of the AOB emulsions were significantly lower than that of the corresponding Tween40 emulsion throughout the storage period tested, showing the greater oxidative stability of the AOB emulsions (data not shown).

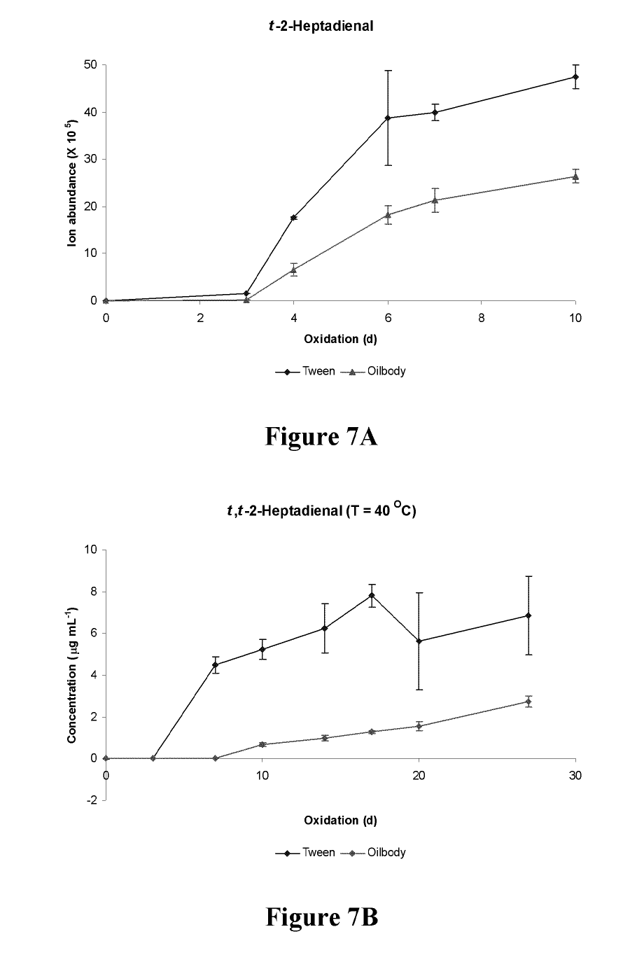

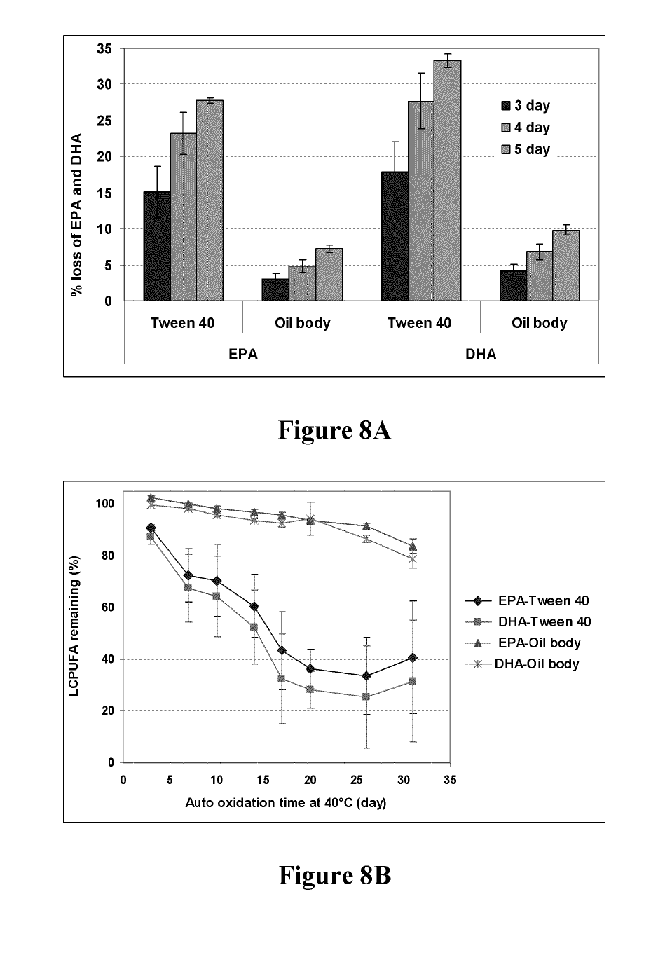

The concentration of 2,4-heptadienal in the tuna oil emulsion made with the oleosin extract was significantly lower than that made with Tween40, showing the greater oxidative stability of the oleosin emulsion (FIG. 7). This showed that antioxidant effect of canola oleosin is not limited to canola oil but is extended to fish oil such as tuna oil. Additional evidence in support of this was provided by fatty acid data. The EPA and DHA contents of the tuna oil emulsion made with olesoin extracted from canola meal depleted more slowly than those of the Tween40 emulsion (FIG. 8), with greater than 90% of DHA remaining after 5 days at 60° C. compared to less than 70% for the Tween40 emulsion.

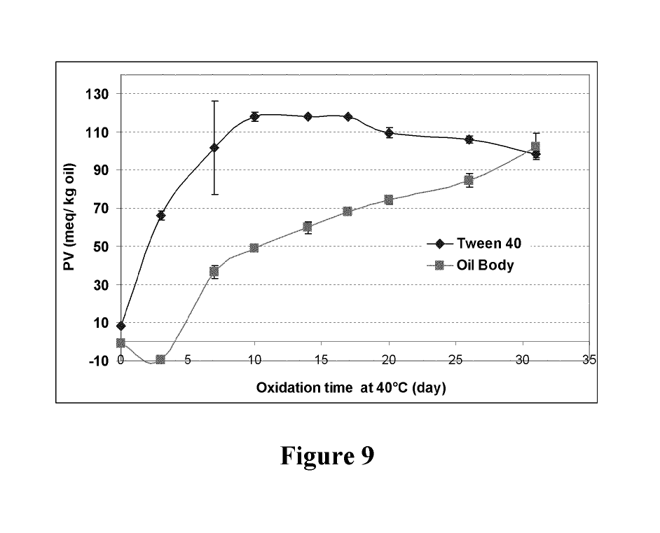

FIG. 9 shows the rate of development of hydroperoxides (as represented by PV) during accelerated oxidation (40° C., exposed to air) of the oleosin- and Tween 40-stabilised emulsions. When subjected to accelerated oxidation, the PV of the Tween 40-stabilised emulsion rose sharply without an apparent induction period reaching a value of 120 meq/kg oil after 10 days; the PV gradually declined beyond this point which can be explained as been due to the rate of formation of hydroperoxides falling below the rate of their degradation in to secondary oxidation products such as aldehydes and ketones. The PV value of the oleosin-stabilised emulsion did not approach the PV maximum of the Tween 40-stabilised emulsion (120 meq/kg) even after 30 days accelerated at which point the experiment was terminated. The result demonstrates the superior oxidative stability of the oleosin-stabilized emulsion over the Tween 40-stabilized emulsion.

The artificial oil bodies (AOBs) produced from tuna oil and oleosin dispersed easily in water to form tuna oil-in-water emulsions. The emulsions did not separate when stored for 1 week at 4° C. irrespective of the secondary surfactant used (phospholipid, monoglyceride or sodium stearoyl lactylate, SSL). In contrast, the emulsions produced from tuna oil and Isolexx (canola protein isolate) with and without phospholipid were unstable and separated within hours of preparation. At 40° C., the sodium caseinate emulsion was the most stable showing no separation after 1 week. The oleosin-stabilised emulsions containing phospholipid or SSL were practically unseparated after 1 week at 40° C.

### Example 5

### Emulsification and Antioxidant Efficacy of Oleosin Relative to Other Protein Ingredients

Comparisons were made with sodium caseinate, which is widely used as an emulsifier as well as “Isolexx”, which is a canola protein isolate produced in Canada and being promoted as a food-grade emulsifier. The following formulations were tested for physical stability and oxidative stability.

1. Tuna oil+oleosin+phospholipid
2. Tuna oil+Isolexx (canola-based protein emulsifier marketed by BioExx, Canada)
3. Tuna oil+Isolexx+phospholipid
4. Tuna oil+sodium caseinate

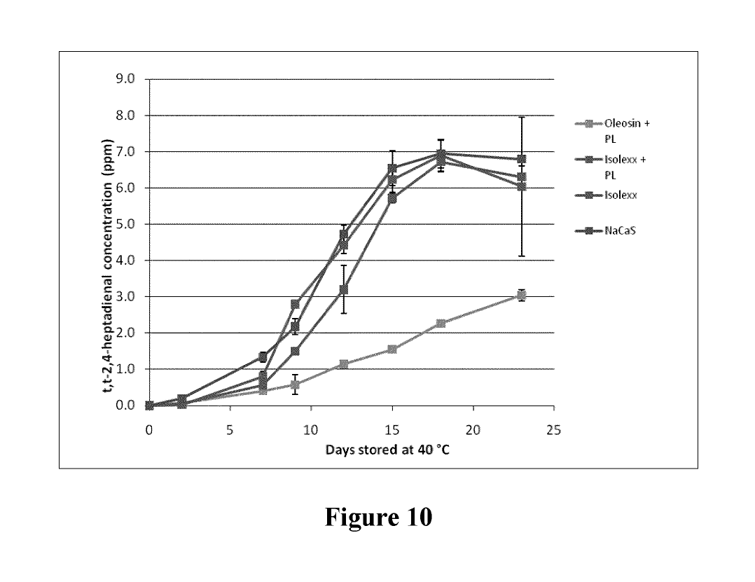

Accelerated oxidation conditions (storage at 40° C., exposed to air) were used to compare oxidative stability using trans,trans, 2,4-heptadienal as a marker of oxidative degradation of tuna oil omega-3 fatty acids. FIG. 10 shows the development of trans,trans, 2,4-heptadienal within emulsions during storage. All emulsions with the exception of oleosin (plus phospholipid) emulsion reached maximum oxidation within 18 days. The sodium caseinate and Isolexx emulsions reached heptadienal concentration of 3.0 ppm within 9-10 days, whereas the oleosin emulsion did not reach same level of oxidation until after 24 days demonstrating the superior antioxidant properties of oleosin compared with sodium caseinate and Isolexx.

### Example 6

### Role of Secondary Surfactants on Artificial Oil Body Stability

Based on previous work the presence of phospholipid in addition to oleosin was necessary to produce emulsions that did not coalesce on storage. The present inventors investigated the essentiality of phospholipid for stability of artificial emulsions by preparing emulsions where phospholipid was replaced by Tween40, monoglyceride and SSL as below. Phospholipid, Tween 40, MAG and SSL were used at the same level (1% w/w by weight of oil).

a. Tuna oil+oleosin and phospholipid
b. Tuna oil+oleosin and Tween 40
c. Tuna oil+oleosin and monoglyceride
d. Tuna oil+oleosin and sodium stearoyl lactylate (SSL)

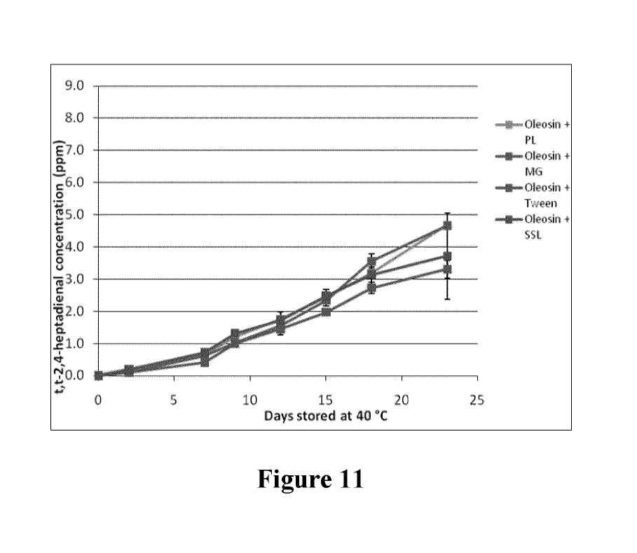

Accelerated oxidation conditions (storage at 40° C., exposed to air) were used to compare oxidative stability using trans,trans, 2,4-heptadienal as a marker of oxidative degradation of tuna oil omega-3 fatty acids. FIG. 11 shows the development of trans,trans, 2,4-heptadienal within emulsions during storage. There was no significant difference in the rate of development of heptadienal between the different emulsions showing that replacement of phospholipid with Tween 40, monoglyceride or SSL did not adversely affect the oxidative stability of oleosin-based artificial oil bodies.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The present application claims priority from AU 2011900383 filed 7 Feb. 2011, the entire contents of which are incorporated herein by reference.

All publications discussed and/or referenced herein are incorporated herein in their entirety.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### REFERENCES

Abenes et al (1997) Plant Cell Reports 17:1-17.
Beisson et al (2001) Plant Physiol. Biochem. 39: 623-630.
Bhatla et al (2010) Biotechnol. Adv. 28: 293-300.
Capuano et al (2007) Biotechnol. Adv. 25: 203-206.
Fisk et al (2008) Euro. J. Lipid Sci. and Tech. 110: 962-68.
Ghodsvali et al. (2005) Food Res. Int. 38:223-231.
Gray et al (2010) Eur. J. Lipid Sci. Technol. 112:741-749.
Huang (1992) Annu. Rev. Plant Physiol. Plant Mol. Biol. 43:177-200.
Huang (1994) Curr. Op. Struct. Biol. 4:493-498.
Huang (1996) Plant Physiol. 110: 1055-1061.
Lin et al (2005) Plant Physiol. Biochem. 43: 770-776.
Liu et al (2009) J. Agric. Food Chem. 57: 2308-2313.
Manamperi et al (2010) J. Am. Oil Chem. Soc. 87:909-915.
Murphy and Cummins (1989) Phytochemistry 28:2063-2069.
Needleman and Wunsch (1970) J. Mol. Biol. 48:443-453.
Roux et al (2004) J. Agric. Food Chem. 52: 5245-5249.
Scott et al. (2010) Plant Biotechnol. J. 8:912-927.
Shen and Wijesundera (2009) Oxidative Stability of Canola Oil Bodies, American Oil Chemists' Society Annual Meeting, May 2009. Orlando, USA.
Shimada and Hara-Nishimura (2010) Biol. Pharm. Bull. 33: 360-363.
Tzen and Huang (1992) J. Cell Biol. 117:327-335.
Tzen et al (1993) Plant Physiol. 101: 267-276.

1. An artificial oil body comprising oleosin, surfactant, and an oil comprising polyunsaturated fatty acids with four or more double bonds.

2. The oil body of claim 1, wherein the surfactant is a phospholipid.

3. The oil body of claim 1, wherein at least 5% of the polyunsaturated fatty acids have four or more double bonds.

4. An artificial oil body comprising oleosin, surfactant, and an oil comprising fatty acids, wherein at least some of the surfactant is a surfactant other than a phospholipid.

5. The oil body according to claim 1, wherein the oleosin is an oilseed oleosin.

6. The oil body according to claim 1, wherein the oil is a marine oil and/or a fish oil.

7. The oil body according to claim 1, wherein at least 50% of the polyunsaturated fatty acids are in the form of glycerides.

8. (canceled)

9. The oil body according to claim 1 which further comprises one or more other substances.

10. The oil body of claim 9, wherein the other substance is a bioactive substance.

11. The oil body according to claim 1 which has a size between about 0.1 and about 100 μm.

12. A composition comprising one or more artificial oil bodies according to claim 1, and a carrier.

13. (canceled)

14. A method for treating or preventing a condition which would benefit from fatty acids in a subject in need thereof which comprises administering to the subject the oil body of claim 1.

15-21. (canceled)

22. A method of producing artificial oil body comprising
i) obtaining oleosin, surfactant, and oil comprising polyunsaturated fatty acids with four or more double bonds, and
ii) mixing the oleosin, the surfactant and the oil to produce the artificial oil body.

23-26. (canceled)

27. A method of partially purifying oleosin from a plant extract comprising
1) adjusting the pH of the extract to a pH of at least about 11.5,
2) separating 1) to produce a solid and liquid phase and selecting the liquid phase,
3) reducing the pH of the liquid phase to precipitate the proteins,
4) separating 3) to produce a solid and liquid phase and selecting the solid phase, and
5) dispersing the solid phase in a carrier.

28. The method of claim 27, wherein step 3) comprises reducing the pH of the liquid phase to a pH less than about 7.

29. The method according to claim 27 which comprises use of a solvent other than an organic solvent.

30. The method according to claim 27, wherein the plant is an oilseed.

31. The method according to claim 27, wherein the extract is meal produced following the extraction of oil.

32. The oil body of claim 2, wherein at least 5% of the polyunsaturated fatty acids have four or more double bonds.

33. The oil body according to claim 2, wherein at least 50% of the polyunsaturated fatty acids are in the form of glycerides.
